(19) United States
(12) Patent Application Publication
(10) Pub. No.: US 2002/0021832 A1
(43) Pub. Date: Feb. 21, 2002

(54) Method and apparatus for producing anaglyphic 3-D images

(76) Inventor: Mark Thomas Dawson, Te Awamutu (NZ)

Correspondence Address: Mark Dawson, 555 Rewi Street, Te Awamutu, NZ

(21) Appl. No.: 09/892,351

(22) Filed: Jun. 28, 2001

(30) Foreign Application Priority Data
Jun. 30, 2000 (NZ) 505513

(51) Int. Cl. G06K 9/00

(52) U.S. Cl. 382/154; 382/167

(57) ABSTRACT

A production method for still or motion colored anaglyphic 3D images in RGB format. Contrasts of the full spectrum are perceived within each color channel via red/green-blue filter gels enabling a dynamic and balanced contrast with bright register and near total extinction of the opposing eyes view including bright colors and white.

In one preferred embodiment, full color is presented to both eyes simultaneously via stereoscopic channeling of anaglyphic primary colors viewed through synchronous presentations of electro-optic/anaglyphic filters. One embodiment enables concurrent perception of vertical and horizontal parallax where full colour to each eye is also achieved. 2D compatibility is also addressed.

Another preferred embodiment enables a choice between two autostereoscopic programs from one image signal displayed anaglyphically on an autostereoscopic screen. FIG. 14.27.

Features of this invention enable the realization of an instant stereoscopic anaglyphic camera and also a quadrascopic anaglyphic camera, FIG. 15.

### CROSS-REFERENCE TO RELATED APPLICATIONS.

New Zealand patent application 505513. Jun. 30, 2000.

### STATEMENT REGARDING FEDERALLY SPONSORED RESEARCH OR DEVELOPMENT.

Not applicable.

### REFERENCE TO A MICROFICHE APPENDIX.

Not applicable.

### BACKGROUND OF THE INVENTION.

U.S. Classes. 348/60, 348/42, 382/154.

Conventionally, anaglyphs have involved viewing 3D images via colored gels, typically, red for the left view and green or blue for the right view. The viewing gels correspond to the color coding or anaglyphic color channeling of the left and right views displayed in the color record of the anaglyphic image. The red viewing gel cancels any red in the anaglyph causing it to dissolve into the white of the page while revealing any blue colors. The blue viewing gel cancels blue while revealing red. This results in a monochromatic image often referred to as black and white. Color anaglyphs have been possible but there has been difficulty with retinal rivalry of brightness or hue contrasts and there has also been difficulty with ghosting or double imaging of bright colors and white. Anaglyphs have been dim to view in order to avoid ghosting and as a result of viewing through colored gel. Retinal rivalry is apparent when viewing one's surroundings through red or green-blue anaglyphic gel. The red gel reveals a monochromatic range of hues from black to a bright red (which equates with white) The blue gel reveals a broader spectrum biased toward blue including bright blue (which equates to white). When a red object is observed, the red gel reveals it as pale to near white while the blue gel reveals it as dark to black, depending on the actual color temperature of the object. When a green or blue object is observed, the red gel reveals it as dark to black while the blue gel reveals it as green-blue to near white, depending on the actual color temperature of the object. Such retinal rivalry is a result of the viewing gels presenting filtered hue contrasts of unbalanced brightness. Anaglyphic viewing causes an observer to perceive a spectral split as the colored viewing gels are necessarily from approximately opposite ends of the spectrum. Accordingly anaglyphic images are commonly duo-tone consisting of two colors from approximately opposite ends of the spectrum and reveal a monochromatic image.

Prior art U.S. Pat. No. 5,491,646 achieves an R/GB split of red left and green-blue right with green being minimized, but matters of retinal rivalry, double imaging of bright colors and white, spectral split and full colour perception are not addressed.

Prior art U.S. Pat. No. 3,770,887 achieves a full colour stereoscopic display from a single black and white camera and monitor where a multiplex of primary colors alternate between each eye. But the images are not anaglyphic and this system is electro-mechanical and requires electro-mechanical viewing apparatus and results in an alternating strobe being presented for view.

Prior art U.S. Pat. No. 5,260,773 achieves a strobe free monochromatic perception and addresses spectral split, but matters of colour perception, retinal rivalry, double imaging of bright colors and white and computer generation of anaglyphs are not addressed.

Prior art U.S. Pat. No. 6,037,971 achieves an R/GB split of red left and green/blue right from left and right cameras and assists anaglyphic retinal rivalry for pure red and pure blue images by the addition of other colour information from the same camera. But matters of broad-spectrum anaglyphic contrast balance, double imaging of bright colors and white, spectral split, and full colour perception of anaglyphs are not addressed.

Methods other than anaglyphic for displaying three-dimensional images from a single two-dimensional display include;

Electro-optic shutter glasses, typically used for TV monitors and also for projected images, alternate rapidly between open and shut states to reveal alternating screen displays representing the left and right views to be received by the left and right eyes. The speed of alternation can match the field rate causing an observer to be subjected to a strobe effect of half frames (fields) alternating between the left and right eyes. It is well known in Electroencephalography (EEG) that a strobe effect can induce abnormal electrical discharges. Patients are subjected to a strobe light to elicit their potential for epileptic seizures. To subject a viewer to a left/right alternating 25 Hz strobe effect therefore has potential for harm.

Polarized systems, typically used for screen-projected images, provide excellent colour perception. But two separate projections are required for a strobe free presentation of motion and the degree of polarized extinction of the opposite eyes view is degraded should an observer tilt their head.

Lenticular systems, typically used for printed 3D images, enable unaided viewing of the stereoscopic image with but also allow the view intended for the opposite eye.

### BRIEF SUMMARY OF THE INVENTION.

The present invention incorporates the following embodiments and applications.

Item 1. Anaglyphic production method via anaglyphic contrast balance.

Item 2. Color perception of strobe free+spectral split free still or motion R/G-B to G-B/R modulating anaglyphic display via electro-optic/anaglyphic viewing filters.

Item 3. The instant modulating anaglyphic filter.

Item 4. Full color left/right concurrent viewing of strobe free stereoscopic RGRB cycle modulating anaglyph. Still or motion.

Item 5. Interactive three-dimensional perception of concurrent vertical and horizontal parallax via anaglyphic/lenticular viewing of still or moving anaglyphic image displayed as print or on a monitor.

Item 6. The instant stereoscopic and quadrascopic anaglyphic camera still or motion.

Item 7. Isolation of unaided two-dimensional display from a modulating anaglyphic record.

Item 8. The selection between two autostereoscopic color programs from one image signal via anaglyphic/lenticular method.

Item 1. ANAGLYPHIC CONTRAST BALANCE PRODUCTION METHOD OVERVIEW.

The Anaglyphic Contrast Balance (ACB) encompasses stages of treatments, namely, Stereo Color Contrast Filter, Luminosity Compression, Colour Wash, and Contrast expansion. These stages are fully described later herein. The following however is an overview of the ACB process involving steps of,

1. Isolating, aligning and or synchronizing stereoscopic pair, if this has not been automatically achieved in the process of their capture.

2. Using a computer filter to selectively adjust the color records of stereo pairs so as to effect an anaglyphically viewed contrast balance of the stereo pair when processed.

3. Using a computer filter to compress the luminosity of the stereo pair.

4. Using a computer filter to color wash the images as spectrally opposite anaglyphic color channels. Or as an alternative to luminosity compression and colour wash, using a computer filter to selectively remove the red color record from one image of the stereo pair and to selectively remove the green and blue color records from the other image in the stereo pair to color saturate the images as approximately opposite spectral hues.

5. Using a computer program to superimpose, blend and fuse the stereo pair so that each of the images are equally represented in the resulting single image composite.

6. Using a computer program to expand the RGB contrast levels of the composite and thus of the anaglyphic color channels to reveal a bright three dimensional anaglyphic image with balanced and dynamic contrasts that is perceived in colour when viewed through red/green-blue viewing gels.

When observing such an anaglyphic image, still or motion, through red/green-blue viewing gels, the observer receives details and degrees of balanced contrasts from the whole color spectrum inside each anaglyphic color channel.

The red viewing gel allows perception of the dark end of it's views spectrum by revealing graduations of green and bluer hues and allows perception of the bright end of it's spectrum by revealing redder hues. The green-blue viewing gel allows perception of dark and light hues by the same mechanism but contrary in manner and also allows perception of green and blue.

The color and stereo information received from such viewing is perceived as a 3D image in color. The viewing orientation of the anaglyphic color channels may be produced so that the left image of the stereo pair is to be viewed through red gel and the right image is to be viewed through green-blue gel or visa versa. This is determined by interchanging the color channeling filter processes that are mutually applied to the left and right images.

Item 2. R/G-B to G-B/R (red/ green-blue to green-blue/red) MODULATING ANAGLYPH OVERVIEW.

The anaglyphic color channels of an anaglyphic display are prepared so as to switch their display between red/left and green-blue/left viewing orientation. When viewed through synchronized electro-optic/anaglyphic red/green-blue transition viewing filters, such as variable birefringence polarized interference filters, the observer receives both halves of the anaglyphic spectrum for each eye as rapid modulations of equal brightness without a strobe effect as both eyes are viewing continuously.

Perception of an approximation of full color to each eye is achieved along with contrast balance. Double imaging of bright colors and white is addressed via Luminosity Compression, which is an embodiment of the present invention described herein.

Item 3. INSTANT MODULATING ANAGLYPHIC FILTER OVERVIEW.

The processes of the current invention may be effected by a computer program or by a non-digital process through analogue video filters, fader and VSPI switching. Where switching between the treatments for the anaglyphic color channels is automated, this enables the instant production of modulating anaglyphic records referred to above.

Item 4. RGRB (red, green, red, blue) CYCLE MODULATING ANAGLYPH OVERVIEW.

When an RGRB cycle of modulating anaglyphic primary color channels is viewed through synchronized presentations of electro-optic/anaglyphic red-green-red-blue transition color filters, such as variable birefringence polarized interference filters, the observer receives a multiplexed full color spectrum and contrast balance to each eye in anaglyphic opposition without a strobe effect as both eyes are viewing continuously. Double imaging of bright colors and white is addressed via Luminosity Compression, which is an embodiment of the present invention described herein.

Item 5. VERTICAL AND HORIZONTAL PARALLAX VIA ANAGLYPHIC/LENTICULAR COMBINATION OVERVIEW.

When stereoscopic anaglyphic images representing upper and lower views are interpolated for viewing behind a horizontally oriented lenticular array of lenses, the multiple visual channels available enable interactive perception of concurrent vertical and horizontal parallax from a printed image. The printed interpolated images may also display motion.

Field interpolated anaglyphic images that represent vertical and horizontal parallax and are displayed on a monitor behind a lenticular array and may also be modulated, as referred to above.

Item 6. INSTANT ANAGLYPHIC CAMERA.

The principles of anaglyphic production from the present invention and in particular those of the instant anaglyphic contrast balance filter enable the realization of an instant anaglyphic still or motion camera. A quadrascopic camera captures images that represent vertical and horizontal parallax for processing into anaglyphic record.

Item 7. ISOLATION OF UNAIDED TWO DIMENSIONAL DISPLAY FROM MODULATING ANAGLYPHIC RECORD.

A process of selective color subtraction enables the selective display of one anaglyphic color channel for unaided viewing.

Item 8. THE SELECTION BETWEEN TWO AUTOSTEREOSCOPIC COLOR PROGRAMS FROM ONE IMAGE SIGNAL VIA ANAGLYPHIC/LENTICULAR METHOD

By color subtraction, an observer may select between two modulating anaglyphic programs that are stereoscopically displayed by lenticular means enabling unaided color viewing.

### OBJECT OF THE INVENTION.

Anaglyphic 3D viewing, though long established, has the benefit of being usable across multi-media formats and involves low cost colored viewing gel or glass lens. This invention addresses the quality of the anaglyphic image enabling an improved bright register and addresses retinal rivalry enabling an anaglyphically perceived contrast balance. The process of this invention enables an improved extinction of the opposite eyes view and improved color perception.

One embodiment of this invention addresses the spectral split associated with anaglyphs and also addresses the strobe effect associated with electro-optics. Another embodiment of this invention enables the perception of full color to both eyes. Another embodiment also enables the interactive perception of concurrent vertical and horizontal parallax. Another embodiment enables the conversion of three-dimensional anaglyphic program for unaided two-dimensional viewing.

Another embodiment of this invention also enables the unaided perception of a choice of two stereoscopic programs from one image signal.

Stereoscopic methods, including anaglyphs, have not prior enabled perception of 3D images, still or motion, in full colour to both eyes and with concurrent vertical parallax. Holographic images do enable perception of vertical parallax, but are monochromatic and are not motion pictures.

The processes of this invention may be achieved via easy and convenient computer processing. As can be appreciated from the above descriptions of the prior arts deficiencies in relation to producing 3D images, and particularly for anaglyphic images, it would therefore be advantageous to be able to produce anaglyphic images:

a) Easily and conveniently via computer program for display in existing modes of RGB format as print, projected image, LCD or CRT monitor display and so forth.

b) Or alternatively, using existing analogue color selective video filters, brightness and contrast filters and field rate switching.

c) Where such images may be fabricated as drawings, diagrams or print, or may be real as in photography, still or motion and may be reproduced from a recording medium, sent on line or broadcast.

d) Where there was an improved bright register with a dynamic and balanced contrast of the anaglyphically viewed image, thus eliminating retinal rivalry.

e) That enabled a stable image to be perceived as three-dimensional when viewed anaglyphically by enabling near total extinction of the opposite eyes view including bright colors and white, thus addressing ghosting.

f) That enabled the option of production of stereoscopic images to be perceived in color, or to be perceived as monochromatic when viewed anaglyphically.

g) That eliminated the left/right spectral split associated with anaglyphic viewing.

h) That eliminated the strobe effect associated with electro-optics by enabling each eye to have a continuous view of equal brightness.

i) That enabled the full anaglyphic spectrum (an approximation of full color) to be presented to both eyes.

j) That enabled full color perception to both eyes simultaneously while maintaining anaglyphic stereoscopic channeling and where extinction of the opposing channel was not degraded by tilting ones head.

k) That enabled the presentation of multiple anaglyphic views from a printed image.

l) That enabled the separation of four visual channels from a two-dimensional monitor display.

m) That enabled the interactive and concurrent perception of vertical and horizontal parallax.

n) That were instantly produced from a camera as still or motion video or as printed image.

o) That could be reprocessed for unaided viewing of two or more programs from one image signal.

p) That could be viewed unaided with a choice between two three-dimensional programs from one image signal.

### BRIEF DESCRIPTION OF THE SEVERAL VIEWS OF THE DRAWING

The processes disclosed herein are suited to computer program treatments of digitized images and are also suited to non-digital treatments. Accordingly, the accompanying block diagrams showing the flow path of the invention processes are synonymous with both digital and non-digital treatment.

FIGS. 1.10 and 1.11 represent a stereo pair (the left and right views) that together form the stereoscopic image of a still or motion picture.

FIGS. 2.12 and 2.13 represent an example of an observers perception of the retinal rivalry of contrast of a color record in a stereo image pair when viewed anaglyphically where 2.12 is viewed through red gel and 2.13 is viewed through blue gel.

FIGS. 2.14 and 2.15 represent an example of an observers perception of an anaglyphic contrast balance of a color record in an anaglyphic image when viewed anaglyphically, following a selective treatment of the color records with the ACB Stereo Color Contrast Filter in accordance with one preferred embodiment of the present invention.

FIG. 3 displays the effect of the Luminosity Compression filter that is to be applied to both the left and right images of the stereo pair.

FIG. 3.16 is a histogram showing the combined RGB color records of an image treated with the ACB Stereo Color Contrast filter prior to the treatment of the Luminosity Compression filter.

FIG. 3.17 is a histogram showing the combined RGB colour records of the same image after the treatment of Luminosity Compression filter in accordance with one preferred embodiment of the present invention.

FIG. 4.18 displays separated RGB color histograms representing the effect of the Color Wash filter treatment applied to the image to be viewed through red gel (that has been prior treated by the luminosity compression filter) in accordance with one preferred embodiment of the present invention.

FIG. 4.19 displays separated RGB colour histograms representing the effect of the color wash treatment applied to the image to be viewed through green-blue gel (that has been prior treated by the luminosity compression filter) in accordance with one preferred embodiment of the present invention.

FIG. 5 represents a histogram showing the combined RGB color records of both the left and right color washed images following their superimposition and blending into a single composite image that is a stereoscopic anaglyphic image in a contrast compressed state in accordance with one preferred embodiment of the present invention.

FIG. 6 represents a histogram of the RGB contrast expansion of an anaglyphic image from it's contrast compressed state in accordance with one preferred embodiment of the present invention.

FIG. 7.20 represents a complete video frame consisting of 625 field lines at 50 Hz for the PAL system or 525 field lines at 60 Hz for the NTSC system. Its top left portion is highlighted and is shown enlarged as FIG. 7.21.

FIG. 7.21 represents the portion of a video frame highlighted in FIG. 7.20. The top left portion of FIG. 7.21 is also highlighted and is shown further enlarged as FIGS. 7.22 and 7.23.

FIG. 7.22 represents the odd field lines of an LCD screen Cathode Ray Tube or other such monitor or screen that are displayed 1-625 PAL or 1-525 NTSC in alternation with the even lines shown in FIG. 7.23. Only six odd field lines are here shown.

FIG. 7.23 represents the even field lines that are displayed 2-624 PAL or 2-524 NTSC in alternation with the odd field lines shown in 7.22. Only six even field lines are here shown.

FIG. 8 represents a block diagram of the flow path of stereo pair 8a and 8b, or of any separate video image signals digital or analogue, through the processes of an Anaglyphic Contrast Balance Filter which is an arrangement of filters and blender described herein in accordance with one preferred embodiment of the present invention.

FIG. 9 represents a block diagram of the flow path of stereo pair 9a and 9b, or of any separate video image signals a digital or analogue, through the processes of the Modulating Anaglyphic Contrast Balance Filter which is an arrangement of filters, circuits, switches and blender described herein in accordance with one preferred embodiment of the present invention.

FIG. 10 represents a block diagram of the flow path of a stereo pair 10a and 10b from the CCD'S of a stereoscopic video camera or from any separate video image signals digital or analogue, through the processes of the RGRB Cycle Modulating Anaglyphic Filter which is an arrangement of filters, circuits, switches and blender described herein in accordance with one preferred embodiment of the present invention.

FIG. 11 represents a block diagram of the flow path of a modulating anaglyphic video signal through the process of its transmission of synchronizing signals to electro-optic/anaglyphic viewing filters for the synchronization of their anaglyphic filter presentations with anaglyphic color channel orientations displayed on a monitor.

FIG. 12 represents a block diagram of the flow path of two vertically displaced stereo pairs, or of any four separate video image signals, digital or analogue, through the processes of the Quadrascopic Anaglyphic Contrast Balance Filter which is an arrangement of filters, circuits, switches and blenders described herein in accordance with one preferred embodiment of the present invention.

FIG. 13.24 represents a cross section side view of odd and even field lines displayed under a horizontally oriented lenticular array of lenses. Only 12 field lines are shown greatly enlarged. FIG. 13.25 represents an observer's upper anaglyphic view revealing the even field displays and FIG. 13.26 represents an observer's lower anaglyphic view revealing the odd field displays.

FIG. 14.27 represents a cross section plan view of the odd and even field lines of a monitor rotated 90 degrees and displayed under a vertically oriented lenticular array of lenses. Only 12 field lines are shown greatly enlarged.

FIG. 14. 28 represents an elevation view of the field lines shown in FIG. 14.27.

FIG. 14.29 represents the line of sight of left and right views being refracted through a single lenticular lens greatly enlarged. FIG. 14.30 represents the line of sight of an unaided left view and FIG. 14.31 represents the line of sight of an unaided left view that mutually reveal opposing field lines.

FIG. 15 represents a quadrascopic camera which is an embodiment of the present invention.

### DETAILED DESCRIPTION OF THE INVENTION

ITEM 1. ANAGLYPHIC PRODUCTION METHOD VIA ANAGLYPHIC CONTRAST BALANCE.

The stages of the ACB (Anaglyphic Contrast Balance) process are described here in detail.

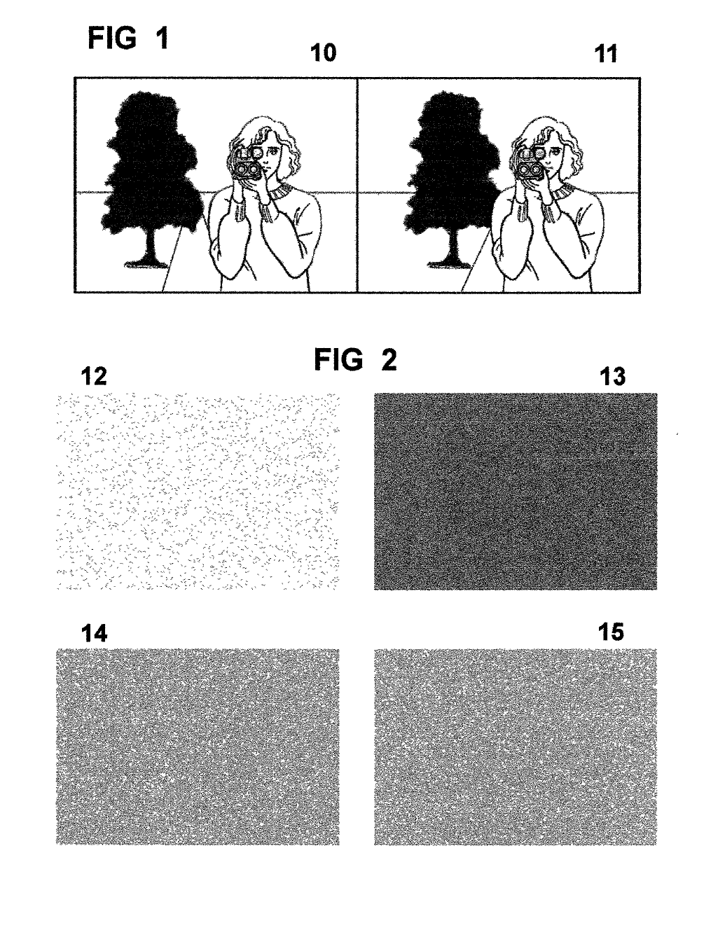

STEREO PAIRS refer to FIG. 1.

Stereo Pairs consist of the left 1.10 and right 1.11 stereoscopic views that are to be offered exclusively to each corresponding eye. Typically they represent views available to each eye from the original screen. Good quality images in a stereo pair make a good quality anaglyphic image. For those familiar with the art, the two images of a stereo pair are necessarily identical in size and should be positioned and set in a correct manner of alignment to appear as a stereoscopic image within the boundaries of the viewing window, or the edges of the images, when stereoscopically viewed.

Stereo pairs may stills or records of motion and may be isolated as photographic prints, negatives, positives, film, video or computer generated digital image, diagrams cartoon, drawing, painting etc and may be applied across a range of technological fields as well as for entertainment and may be reproduced from a recording medium and displayed, sent on line or broadcast live.

Thermographic infrared detectors reveal grades of temperature by displaying representative colors. An anaglyphic view obtained from a stereo pair of thermographs by using the process here described, assists in making better sense of peculiar colored zones by revealing depth. Diagnosis and or measurement may still be accurately made from either of the stereo pair prior to the process. Remote 3D night vision on a monitor display may also be achieved.

For medical or industrial radiography, an anaglyph may be produced from a stereo pair of x-rays to reveal depth information. An RGB monitor may be used to display instant motion picture x-ray as in fluoroscopy. The further away the object is, the wider the stereo base needs to be to achieve stereopsis. Radio sonar images may provide a stereo pair even for extremely distant objects by increasing the distance between the left and right recording points. Thus anaglyphic imagery can be attained of space and aeronautic views, and sub-aquatic and subterranean features.

For computer processing, the stereo pair may be scanned or digitized or transferred into a suitable computer program. Alternatively the stereo pair may be captured by video camera where they may also be treated via analogue method through the processes detailed herein. Stereoscopic pairs representing moving images recorded on film frames or video fields as separate records of left and right views are also digitized or transferred to a suitable computer program where they may be synchronized and edited if this has not already been achieved.

Sequential stereoscopic pairs recorded on a single medium that alternately present the left and right views (as used for electro-optic/shutter viewing) may be converted into continuous and separate left and right video records by process of duplication and then be processed into an anaglyphic record as described herein. Mention of stereo pairs hereafter refers to either stills or motion pairs.

ACB Stereo Color Contrast Filter (refer to FIG. 2)

The Stereo Color Contrast filter is a solution to retinal rivalry and enables contrasts of the full spectrum from corresponding areas of the stereo pairs to be perceived as equal in brightness and contrast when viewed anaglyphically.

An anaglyphically viewed contrast balance is achieved by the selective isolation of individual color records present in corresponding areas of a stereo pair. Pre-set values of the ACB Stereo Color Contrast Filter, selectively alter the color records in the stereo pair to achieve a contrast balance.

An example follows with reference to FIG. 2.

To solve the retinal rivalry perceived when anaglyphically viewing a red color record, which appears light through the red gel 2.12 and appears dark through the blue gel 2.13, a cyan hue is added to the red color record of the image to be viewed through the red gel making red appear darker through the red gel 2.14. Accordingly, magenta is removed from the red color record of the image to be viewed through green-blue gel making reds appear lighter through green-blue gel 2.15. Thus an anaglyphically viewed contrast balance for the red color record is achieved. Refer to FIGS. 2.14 and 2.15.

An anaglyphic contrast balance may also be achieved by removing black from the color record that appears comparatively too dark when viewed anaglyphically or by adding black to the color record that appears comparatively too light when viewed anaglyphically. But this process harms the perceivable color register of the red color record that is possible with color anaglyphs viewed through red/green-blue gel and so the anaglyphic contrast balance for the red color record as prior described is preferred.

An anaglyphic contrast balance can also be achieved for other hues by isolating and altering their color records as in the examples given above. Such a balance of contrast can be achieved by many variations of addition or subtraction including alterations of brightness or colour saturation, but the alterations should aim to compensate for viewing through colored gel and enable the observer to receive details of degrees of balanced contrasts from the whole colour spectrum inside each anaglyphic color channel. The ACB Colour Contrast Filter serves five functions.

1. To equalize anaglyphically viewed contrasts of brightness between corresponding areas of the stereo pairs.

2. To cause details and graduations of tones from the entire spectrum to be evenly and faithfully presented anaglyphically to each eye as in natural viewing.

3. To adjust color hues to compensate for being viewing through colored gel.

4. To assign degrees of color contrast adjustment appropriate to the efficiency, limitations or nature of the Color Wash treatment that is to follow later.

5. To effect control of the brightness of the resulting anaglyphic image.

The effectiveness of an ACB Stereo Color Filter may be demonstrated when the entire ACB filter processes is applied to a stereo pair that consists of two identical colour test charts which display the additive and subtractive primary colors red, green, blue, cyan, magenta and yellow. The resulting single anaglyphic colour chart reveals balanced contrasts from the whole color spectrum inside each anaglyphic colour channel. An example of such an Anaglyphic Contrast Balance achieved via an ACB Stereo Color Contrast Filter is as follows.

ACB Stereo Color Contrast Filter Values.

| For the image viewed | For the image viewed |
|---|---|
| through red gel. | through blue gel. |
| Red + cyan 95% | Red − magenta 63% |
| Yellow + cyan 50% | Yellow nil treatment. |
| Green − cyan 60% | Green + magenta 35% |
| Cyan − cyan 80% | Cyan nil treatment. |
| Blue − cyan 55% | Blue + yellow 50% |
| Magenta nil treatment. | Magenta − black 40% |
| Black − black 10% | Black − black 10% |

The basic Anaglyphic Contrast Balance addresses the primary colors Red, Green and Blue.

| | |
|---|---|
| Red + cyan | Red − magenta |
| Green − cyan | Green + magenta |
| Blue − cyan | Blue + yellow |

The filter values given above are in absolute percentages so that a percentage of a colour hue can be added to where there was no prior presence of it.

Note that the ACB filter value for black in both the left and right images is reduced. This assists in reducing the contrast of the black color records in the stereo pair to enable uptake of the color wash described later herein. By comparison, should the ACB filter value for black not be reduced, a brighter anaglyph results. Should the ACB filter value for black be increased, the resulting anaglyph is brighter yet.

Such control of brightness is achieved when variation to the ACB Stereo Color Contrast Filter's values for black are followed by the processes of Luminosity Compression and Color Wash which are embodiments of the present invention described later herein. The effect is more subtle where color wash via RGB levels is used.

A computer programs software values for the above color filter values may be pre-set to render all adjustments with a single sweep. Or the color records may be treated individually. For example, the color filter values for the black color records may be adjusted to the nth degree.

Alternatively, selective color adjustments of the video pair may be achieved with a video path through regular existing analogue colour selective video filters.

Variations

For high quality monochromatic anaglyph production, both images of the stereo pair should at this point be de-saturated of colour or rendered as black and white images instead of being selectively colour adjusted as above. Alternative filter values of the ACB Stereo Color Contrast filter are required for alternative methods of Color Wash or anaglyphic colour channel saturation described later herein.

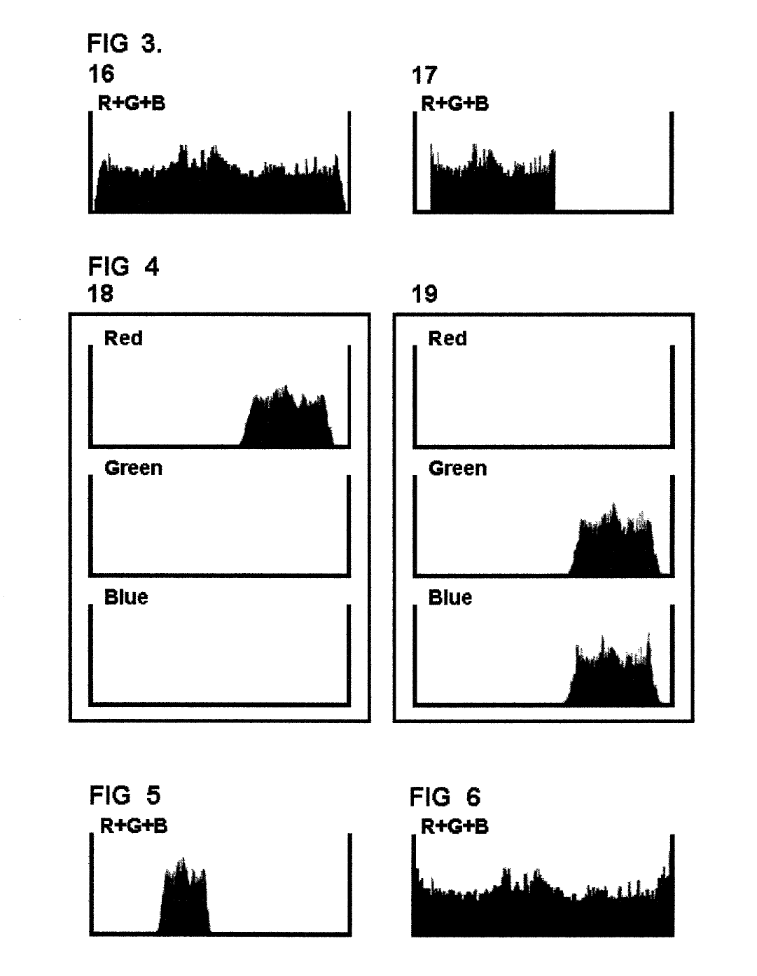

ACB Luminosity Compression refer to FIG. 3.

Luminosity compression is a solution for ghosting or the perception of double images typically evident with the bright and white areas of the stereoscopic anaglyphic image. White present in varying degrees throughout corresponding areas of the stereo pairs fails to adequately take up a saturation of any red, green or blue rendered to it and so tends to fail allocation to an anaglyphic color channel to enable an exclusive view to the appropriate eye. FIG. 3.16 is a histogram showing the combined RGB colour records of an image treated with the ACB Stereo Color Contrast filter prior to the treatment of the Luminosity Compression filter.

FIG. 3.17 is a histogram showing the combined RGB color records of the same image after the treatment of Luminosity Compression filter in accordance with one preferred embodiment of the present invention. Luminosity compression of the stereo pair causes their spectrums from extreme black to white and all contrasts in between (and along with their color hues) to be compressed resulting in reduced output levels. This causes bright colors and white to gather a substance of gray that will take up any red, green or blue rendered to it from the color wash or anaglyphic colour channel saturation that follows (described later herein) to enable image allocation within an anaglyphic colour channel.

Luminosity compression can be achieved with a computer filter that reduces both brightness and contrast thereby reducing the images RGB output levels. A reduction by >20% is required. A reduction by 50% of both brightness and contrast is generally optimal to address ghosting.

Luminosity Compression may also be achieved with a computer filter that reduces contrast via control of RGB levels output. On a scale of 0-255 for output values, a reduction of the highlights output from 255 to 210 is required. A reduction down to 160 is generally optimal to address ghosting. The Luminosity compression may either precede or follow the ACB Stereo Color Contrast Filter treatment. However the colour isolation of the ACB Stereo Color Contrast Filter may more accurately occur prior to compression. An example of Luminosity Compression follows.

ACB Luminosity Compression of the Left and Right Images

Brightness-50%, Contrast-50%.

Or alternatively via RGB levels Control of the left and right images. RGB highlight levels output 160.

Luminosity compression is a requirement for anaglyphs produced via the color balance method of color wash described below.

A computer programs software values for the preceding filter and Luminosity Compression may be pre-set to render all adjustments with a single sweep for each of the pair enabling easy and convenient anaglyph production. Alternatively, Luminosity Compression of the video pair may be achieved with a video path through analogue contrast and brightness video filters.

ACB Color Wash refer to FIG. 4.

As the left and right images of the stereo pair are intended to be exclusively offered to corresponding eyes for viewing through red/green-blue anaglyphic gels, the contrast and colour information of the stereo pair must be placed inside spectrally opposed anaglyphic color channels to enable mutual extinction of left and right views. FIG. 4.18 displays separated RGB color histograms representing the effect of the Color Wash filter treatment applied to the image to be viewed through red gel that has been prior treated by the luminosity compression filter. FIG. 4.19 displays separated RGB colour histograms representing the effect of the colour wash treatment applied to the image to be viewed through green-blue gel that has been prior treated by the luminosity compression filter. Color washing is an embodiment of the present invention. The Color wash for the images to be viewed through red gel renders a saturation of predominantly red and also magenta and yellow, across the shadow, midrange and highlights of the image to be viewed through the red gel allocating all that image's contrasts within a predominantly red color channel.

The Color wash for the images to be viewed through green-blue gel renders a saturation of predominantly green and blue and also cyan, across the shadow, midrange and highlights of the image to be viewed through the green-blue gel allocating all that image's contrasts within a predominantly green-blue color channel. An example of Color Wash via color balance control for anaglyphic colour channel saturation follows.

RED WASH. (for the image to be viewed through red gel)

Shadow levels, Red +100, Green-100, Blue-100.

Mid tone levels, Red+100, Green-100, Blue-100.

Highlight levels, Red+100, Green-100, Blue-100.

GREEN/BLUE WASH. (For the image to be viewed through green-blue gel)

Shadow levels, Red-100, Green+100, Blue+100.

Mid tone levels, Red-100, Green+100, Blue+100.

Highlight levels, Red-100, Green+100, Blue+100.

The above Color Wash saturation of the digitized stereo pair should be caused to also affect transparencies or pixels without color values in the digital record to enable a total saturation. This results in two spectrally opposed anaglyphic color channels, one appearing red-yellow and the other green-blue.

Such complimentary saturations enable placement for the images of the stereo pair inside spectrally opposite anaglyphic color channels.

Though seeming to appear obliterated the contrast and color information remain retrievably intact. The image to be viewed through the red gel now appears a blown out bright red when viewed through the red gel and virtually black when viewed through the green-blue gel. The image to be viewed through the green-blue gel now appears a blown out bright green-blue when viewed through the green-blue gel and virtually black when viewed through the red gel.

This demonstrates:

1. Near total extinction of the opposite eyes view.

2. That the image color washed predominantly red will be viewed by the red gel.

3. That the image color washed predominantly green-blue will be viewed by the green-blue gel.

4. That color hue and contrasts of the stereo pair are contained inside saturated and spectrally opposite channels.

5. That each eye's opposing view will be perceived invisibly as black.

6. That the anaglyphically viewed black for each view will be the saturation of the opposing color wash.

The combination of red and green-blue color channel saturation is herein and throughout referred to as this combination achieves both excellent colour perception and mutual extinction, however it is accepted that other colour combinations may be used without departing from the scope of the present invention.

Alternative Color Washes.

An alternative method of rendering a colour channel saturation for the above filter treated pair is the selective use of RGB levels or curves to mutually subtract the colour record intended for the opposing color channels saturation. Luminosity compression is not required for a color wash via curves or levels output. However, alternative Stereo Color Contrast filter values are required to compensate for the nature of variations in the saturation and to achieve an anaglyphically viewed contrast balance of colour test charts.

Two examples of Color Wash via Curves or Levels Output and their ACB Stereo Color Contrast filter values follow.

### Alternative Example 1.

Colour Wash via Curves or Levels Output.

For the images to be viewed through red gel, both the green and blue output levels are set to the minimum.

Red 0-255, Green 0-0, Blue 0-0.

For the images to be viewed through green-blue gel, the red color output level is set at the minimum.

Red 0-0, Green 0-255, Blue 0-255.

This results in anaglyphic colour channel saturations appearing as with the prior described color wash via color balance, one appearing red-yellow and the other green-blue.

An example of ACB Stereo Color Contrast filter values for the above alternative colour wash example 1 via output levels is as follows:

| For the image viewed | For the image viewed |
|---|---|
| through red gel. | through blue gel. |
| Red + cyan 60% | Red − magenta 48% |
| Yellow + cyan 50% | Yellow nil treatment. |
| Green − cyan 64% | Green + magenta 35% |
| Cyan − cyan 78 | Cyan + magenta 30% |
| Blue − cyan 63% | Blue + yellow 40% |
| Magenta nil treatment. | Magenta − black 25% |
| Black + or − black optional. | Black + or − black optional. |

### Alternative Example 2.

Color Wash via Curves or Levels Output

For the images to be viewed through red gel, both the green and blue color output levels are set to the maximum.

Red 0-255, Green 255-255, Blue 255-255.

For the images to be viewed through green-blue gel, the red colour output level is set at the maximum.

Red 255-255, Green 0-255, blue 0-255.

This results in saturations where the dark contrasts of the image to be viewed through red gel are saturated in graduations of green-blue in which an image can be seen through the red gel, but only a void of white is seen through green-blue gel.

Correspondingly, the dark contrasts of image to be viewed through green-blue gel are saturated in graduations of red-yellow in which an image can be seen through green-blue gel, but only a void of white is seen through red gel. This demonstrates

1. Near total extinction of the opposite eyes view.

2. That the image color washed predominantly red will be viewed by the green-blue gel.

3. That the image color washed predominantly green-blue will be viewed by the red gel.

4. That color hue and contrasts of the stereo pair are contained inside saturated and spectrally opposite channels.

5. That each eye's opposing view will be perceived invisibly as white.

6. That the anaglyphically viewed white for each view will be the saturation of the opposing color wash.

An example of ACB Stereo Color Contrast filter values for the above alternative color wash example 2 via levels output is as follows:

| For the image viewed | For the image viewed |
|---|---|
| through red gel. | through blue gel. |
| Red + cyan 55% | Red − magenta 78% |
| Yellow + cyan 50% | Yellow nil treatment. |
| Green − cyan 65% | Green + magenta 20% |
| Cyan − cyan 80% | Cyan + magenta 10% |
| Blue − cyan 64% | Blue + yellow 60% |
| Magenta nil treatment. | Magenta nil treatment. |
| Black + or − black optional. | Black + or − black optional. |

A computer programs software values for the Color Wash filters described above may follow those of the preceding filters and be pre-set to render all adjustments with a single sweep for each of the pair enabling easy and convenient anaglyph production.

Alternatively, existing analogue video colour filters may supply the required saturations.

ACB Blending and Fusion refer to FIG. 5

The two images, left and right, now become one.

With either of the images of the stereo pair superimposed over the other they can now be blended so that they appear equally prominent. This can be achieved using a computer program to cause the opacity of the image on top to become 50% opaque so that 50% of the image below also shows A blend can be achieved by using a computer program to merge such layers. Or the pixel values of the stereo pair may be averaged by computer program to result in a 50/50 blend of the two images. The separate predominantly red and predominantly green-blue images of the stereo pair are thus fused into a single composite resulting in an anaglyphic image in a contrast-compressed state. FIG. 5 represents a histogram showing the combined RGB color records of both the left and right colour washed images following their superimposition and blending into a single composite image.

A computer programs software values for the image blend may follow those of the preceding filters and be pre-set to render all adjustments with a single sweep.

Alternatively, a 50/50 blended output of the color washed pair may be achieved with an existing analogue video mixer or cross-fader.

ACB Contrast Expansion Refer to FIG. 6

An anaglyphic 3D image is now plainly apparent through red/green-blue anaglyphic gels though it is dim to view. The contrast and color information inside each color channel are still in their compressed state. They can now be expanded and regain details of contrast and color from within each anaglyphic color channel and depending on which method of color wash also utilize the hue of the opposing anaglyphic color channel for anaglyphic black or white.

The expansion can be achieved using a computer program to increase the RGB contrast levels. This has the effect of redistributing the darker and brighter shades of color and contrasts between the lowest and highest frequencies inside their respective anaglyphic color channels. This can be achieved using an RGB levels optimizing program that maximizes the contrast levels of the red, green and blue color records that contain the anaglyphic color channels.

FIG. 6 represents a histogram of the RGB contrast expansion of an anaglyphic image from it's contrast compressed state.

When an RGB levels optimizing program is used, imbalances of brightness and saturation that may have been present between the originating stereo pair are also now balanced.

This process reveals a bright anaglyphic 3D image with near total extinction of each opposite view with a balanced and dynamic contrast perceived as colour when viewed through red/green-blue anaglyphic gels.

A computer programs software values for the ACB Contrast Expansion Filter may follow those of the preceding treatments and be pre-set to render all adjustments with a single sweep. Alternatively existing analogue contrast and brightness video filters may be used. Or for the instant production of anaglyphic images as described above, an instant Anaglyphic Contrast Balance filter may be used to render the stereo pair into an anaglyphic record as described below.

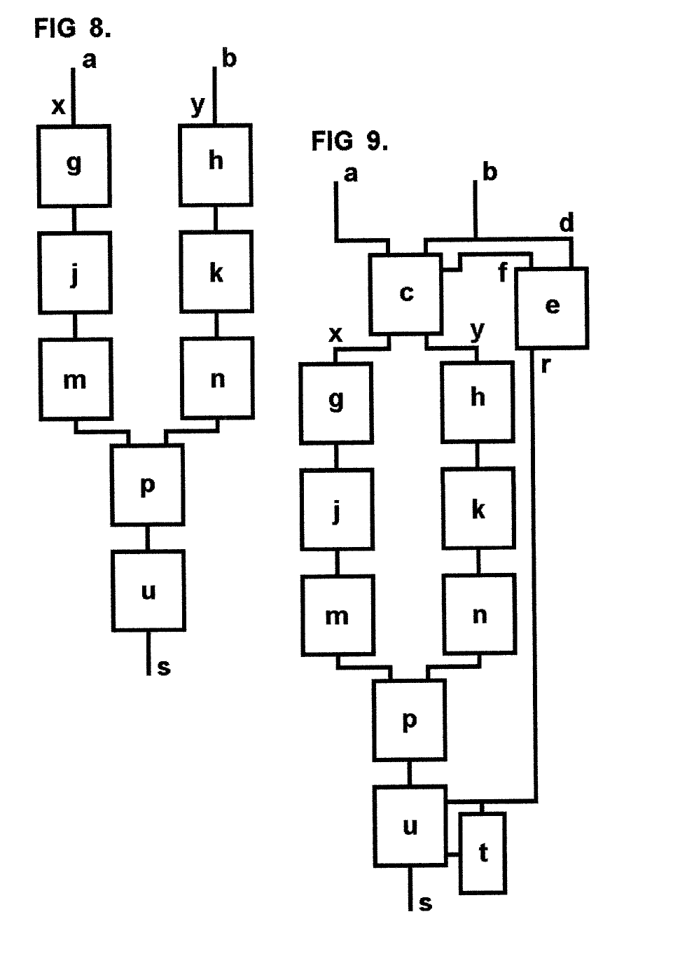

Anaglyphic Contrast Balance Filter (ACB) Refer to FIG. 8

To enable instant still or motion anaglyphic picture production, the stereo pair's footage is filtered by an ACB filter that receives synchronized stereo video inputs 8a left and 8b right into filter paths x and y from a live, pre-recorded, on line or broadcast source, however these may be reversed as desired. Alternatively the input signal may be that of a still image. The selective color adjustments of the ACB stereo color contrast filters that enable an anaglyphic contrast balance for the images to be viewed through red gel occur at 8g. The formula of these filter values is prior outlined above. The selective colour adjustments enabling an anaglyphic contrast balance for the images to be viewed through green-blue gel occur at 8h. The formula of these filter values is prior outlined above. The ACB Luminosity Compression of the stereo pair occurs at 8j and 8k. The formula's and nature of the compression is prior outlined above.

Color washing of the stereo pair occurs at 8m and 8n. The formula's and nature of the Color Wash methods are prior outlined above. The blending of the red oriented video path 8x with the green-blue oriented video path 8y occurs at 8p. The nature and methods of the blending of are prior outlined above.

The RGB contrast expansion that maximizes the RGB levels of the resulting contrast compressed anaglyphic image occurs at 8u.The nature and method of the contrast expansion is prior outlined above.

The RGB expander 8u passes on a continuous single video stream of anaglyphic motion picture 8s that may be broadcast, sent on line, recorded, projected or displayed on a monitor. Alternatively, where the inputs 8a and 8b are still images of a stereo pair, 8s is the resulting still anaglyphic record that is also available for print. This process reveals a bright anaglyphic 3D image with near total extinction of each opposite view with a balanced and dynamic contrast perceived in color when viewed through red/green-blue anaglyphic gels. Such a filter may be computer programmed as software or constructed as integrated circuitry, or may be assembled from analogue color selective filters and contrast and brightness filters and a video cross fader.

Post Production

Additional treatments to assist anaglyphic presentation include any broad spectrum alterations that do not effect the color balance.

Anaglyphic Viewing

As the anaglyphic color channels of the anaglyphic display are color washed as saturations of spectrally opposing hues that are then blended equally together, the anaglyphic viewing filters should present complimentary saturations to enable the mutual extinction of the opposite eyes view and only allow the transmission of the intended view contained within an anaglyphic color channel.

A primary red viewing gel allows an appropriately filtered transmission of varying degrees of contrasts that correlate directly to graduations between the presence and the absence of the predominantly magenta, red and yellow saturated anaglyphic color channel in the anaglyphic image display. Thus the image intended to be viewed through red gel is filtered through from within the entire anaglyphic spectrum of the anaglyphic image. Correspondingly a green-blue viewing gel allows an appropriately filtered transmission of varying degrees of contrasts that correlate directly to graduations between the presence and the absence of the predominantly green, cyan and blue saturated anaglyphic colour channel in the anaglyphic image display. Thus the image intended to be viewed through green-blue gel is filtered through from within the entire anaglyphic spectrum of the anaglyphic image.

The mutually perceived graduations of contrasts from the stereoscopic pair contained in the anaglyphic display are further assisted for anaglyphic contrast balance where the transmission or F stop values of the viewing gels are equal.

Viewing filters may consist of any frequency selective and saturating barriers that correspond to the anaglyphic color channels such as a bandwidth gap.

The combination of red and green-blue gel is herein and throughout referred to as this combination achieves both excellent color perception and mutual extinction, however it is accepted that other color combinations may be used without departing from the scope of the present invention.

ITEM 2. COLOR PERCEPTION OF STROBE FREE AND SPECTRAL SPLIT FREE STILL OR

MOTION RIG-B to G-B/R MODULATING ANAGLYPHIC DISPLAY VIA ELECTRO-OPTIC/ANAGLYPHIC VIEWING FILTERS.

In this embodiment of the present invention for the production of color anaglyphic motion pictures and of anaglyphic still image displayed on a monitor, the principles of electo-optic shutters and anaglyphic viewing are combined.

For 3D motion picture viewing, (and still image via monitor) the strobe effect, associated with electro-optics, and spectral split and retinal rivalry associated with color anaglyphs are eliminated. An anaglyphic image display is caused to modulate it's anaglyphic colour channels between a red/left and a green-blue/left orientation while electro-optic/anaglyphic filters that switch their viewing presentations between red/left and green-blue/left are used as viewing filters where the green-blue filter phase allows perception of both green and blue.

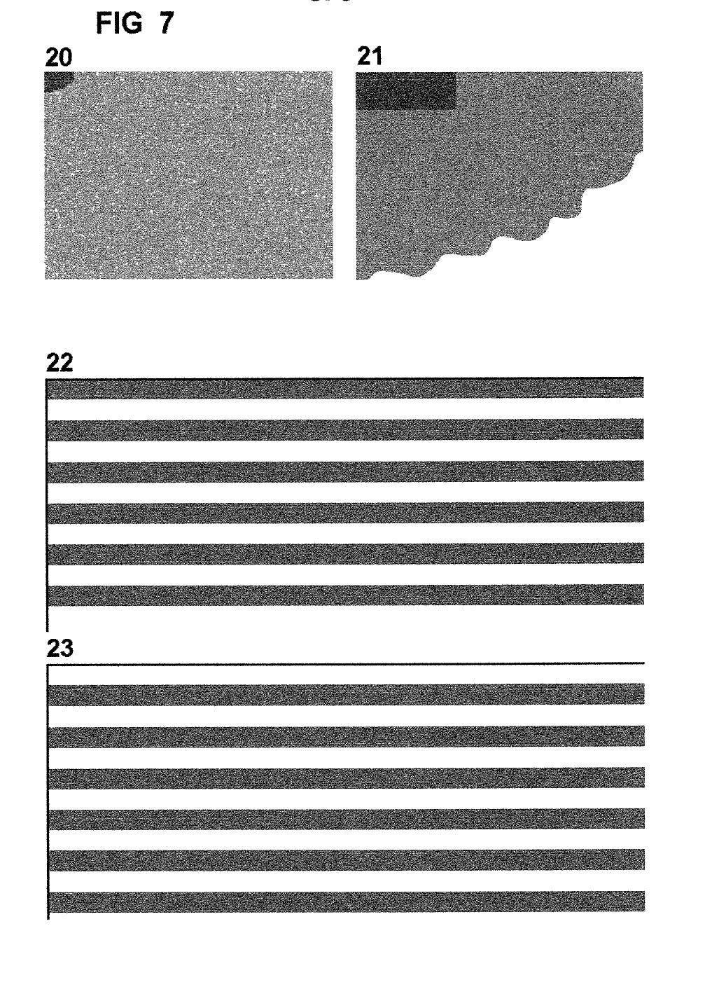

Such electro-optic material is described in US Patent 5,999,240 G Sharp et al. 1999 where two or more electro-optic color filters that each provide independent analogue control of additive primary color are used in stages to elicit field speed presentations of saturated and tunable hues. The above patent is incorporated herein by reference. Modulation of an anaglyphic record may occur at the field rate where a field differentiation circuit may allocate for example the red/left orientation to the odd fields shown in FIG. 7.22 and allocate the green-blue/left orientation to the even fields shown in FIG. 7.23. Other than the very brief period of the vertical sync pulse interval (VSPI) between each field display, there is no strobe effect. The VSPI is present during regular 2D viewing and is not perceived. Such modulation of an anaglyphic record may also occur at the frame rate where frame initiation signals from a field differentiation circuit may allocate a red/left anaglyphic orientation to the first frame detected and then a green-blue/left anaglyphic orientation to the next frame and thus modulate in continuum.

The synchronization of the electro-optic/anaglyphic filter presentations with the field displays of modulating anaglyphic color channels is achieved by wireless transmission of signals representing odd and even fields to the electro-optic/anaglyphic filters. Differentiation of the received signals and electronic switching logic achieve the synchronization.

Synchronization of a frame rate modulation requires an index signal to accompany alternate frame initiations to differentiate the red/left frames from the green-blue/left frames. Wireless transmission then involves signals representing index and frame initiation signals to the electro-optic/anaglyphic filters where the index signal identifies the red/left oriented frames.

With such switching applied to electro-optic/anaglyphic filters, recognition circuitry allocates the correct viewing orientation and a voltage selection enables the appropriate viewing filters to be presented to each eye. This enables each eye to simultaneously view through opposite halves of the anaglyphic spectrum in succession so that the left eye sees through red and then green-blue while the right eye sees through green-blue and then red, in continuum. The resulting effect is that each eye, simultaneously and without a strobe effect, sees only it's intended view as the viewing filters modulate their viewing presentations in sync with the orientation of the anaglyphic color channels in the modulating anaglyphic movie.

Persistence of vision causes each eye, viewing both sides of the anaglyphic spectrum in rapid modulation, to perceive both sides of the anaglyphic spectrum as if constant.

The result is a strobe free and spectral split free, bright anaglyphic 3D image still or motion with near total extinction of the opposing view and with a balanced and dynamic contrast that is perceived in an approximation of full color to each eye when viewed on a monitor or as a screen projection through red/green-blue transition electro- optic/anaglyphic filters. Strobe free and spectral split free viewing of a still anaglyphic image on a monitor is achieved by displaying modulations of red left and green-blue left versions of the still anaglyphic record. As with traditional electro-optic shutters, the perceived resolution of the resulting still or moving anaglyphic images is half that of regular unaided 2D viewing.

However, the strobe effect is eliminated as each eye has a continuous view of equal brightness as in regular 2D viewing.

Production of R/G-B to G-B/R Modulating Anaglyph

To produce such a movie by editing; two versions are made via the process prior described above where one is made with red/left viewing orientation and the other with green-blue/left viewing orientation. The two are then interpolated so as to modulate between red/left and green-blue/left orientation at the field or frame rate when the movie is played. For a field rate example, the red/left version is displayed onto the odd fields as shown in FIG. 7.22 and the green-blue/left version is displayed onto the even fields as shown in FIG. 7.23. Alternatively a modulating anaglyphic filter may be used to instantly render the stereoscopic pair into a video stream of R/G-B to G-B/R modulating anaglyphic record as described below.

ITEM 3. THE INSTANT MODULATING ANAGLYPHIC FILTER for R/GB to GB/R modulation.

Refer to FIG. 9.

Many variations of anaglyphic modulation and frequency are possible. The modulation of anaglyphic color channels can be achieved non-digitally or by using a computer program to interlace differing anaglyphic color channel orientations at the field or frame rate or at any desired rate of modulation. Electronic field rate switching and synchronization is well known and achievable with recognition of odd and even fields. Such a circuit is described in U.S. Pat. No. 4,145,713. R. White 1979. Wireless transmission of the VSPI to the electro-optic shutters is also well known and achievable, as in U.S. Pat. No. 4,424,529J Roese, 1984. The Filtering out of ambient electromagnetic noise from infrared transmission of VSPI is described in U.S. Pat. No.5,325,192 D Allen 1994. These Patents are incorporated heroin by reference.

Field recognition and VSPI switching are herein applied to the anaglyphic colour channel orientations and electro-optic/anaglyphic filter presentations.

To enable instant modulating anaglyphic production, the stereo pair's footage is filtered by an Anaglyphic Contrast Balance filter that is mutually switching its synchronized stereo video inputs, 9a left and 9b right, between the red oriented filter path 9x and the green-blue oriented filter path 9y at the field or frame rate, or whatever rate is desired as governed by the field recognition circuit 9e and electronic stereo switch 9c.

Switch 9c responds to trigger signals 9f sent from the field recognition circuit 9e. Either the left or right synchronized inputs of the stereo pair may provide video signal 9d to the field recognition circuitry 9e for discernment. Thus, in response to the field recognition circuit 9e, stereo switch 9c may for example allocate a field rate modulation with a red/left anaglyphic color channel orientation to be applied to the odd fields detected by passing the left odd video fields from input 9a down filter path 9x and passing the right odd video fields from input 9b down filter path 9y.

Again in response to the field recognition circuit 9e, switch 9c may allocate a green-blue left anaglyphic color channel orientation to the even fields detected by passing the left even video fields from input 9a down path 9y and passing the right even video fields from input 9b down path 9x.

Thus the left and right video streams of the stereo pair, 9a and 9b are caused to mutually switch between the red oriented filter treatments along path 9x and the green-blue oriented filter treatments along path 9y and are further processed as follows;

The selective color adjustments of the ACB stereo color contrast filter that enable an anaglyphic contrast balance for the images to be viewed through red gel occur at 9g. The selective colour adjustments of the ACB stereo color contrast filter that enable an anaglyphic contrast balance for the images to be viewed through green-blue gel occur at 9h. The formula's and nature of these filters is prior outlined above.

The ACB Luminosity Compression of the stereo pair occurs at 9j and 9k. The formula and nature of the compression is prior outlined above.

Color washing of the stereo pair occurs at 9m and 9n. The formula and nature of the Color Wash is prior outlined above.

The blending of the red oriented video path 9x with the green-blue oriented video path 9y occurs at 9p. The nature and method of the merging of 9x with 9y is prior outlined above.

The RGB contrast expansion that maximizes the RGB levels of the resulting contrast compressed anaglyphic image occurs at 9u.The nature and method of the contrast expansion is prior outlined above. Index generator 9t responds to trigger signals 9r sent from field recognition circuitry 9e. Initiating with the first odd field detected by 9e, index pulse generator 9t issues index pulses to the outgoing video signal at 9u at a frequency one quarter that of the modulation rate, being half the frame rate for a field rate modulation, and thus identifies the initiation of alternate fields displaying red/left oriented anaglyphic colour channels.

The RGB contrast expander 9u passes on a continuous single video stream of field rate R/G-B to G-B/R modulating anaglyphic motion picture 9s for broadcast, recording, on line, monitor display or screen projection. The resulting display is a strobe free and spectral split free bright anaglyphic record with a balanced and dynamic contrast that is perceived in an approximation of full color to each eye when viewed through synchronized color corresponding electro-optic/anaglyphic filters.

Such a modulating anaglyphic filter may be computer programmed as software. As a variation to switching, an ACB Stereo Color Contrast filter program may modulate its mathematical values between the red and green-blue oriented filter treatment values.

Alternatively, a modulating anaglyphic filter may be constructed as integrated circuitry, or may be assembled from analogue colour selective filters and contrast and brightness filters that are VSPI switched and a video cross fader.

Variations

Should a frame rate modulation be selected at 9e, a frame rate modulation is effected where field recognition circuit 9e sends frame initiation signals 9f to stereo switch 9c causing a frame rate modulation from the first frame detected. A frame initiation signal 9r is also sent to index generator 9t. Index generator 9t issues index pulses to the outgoing signal of contrast expander 9u at a frequency one quarter that of the modulation rate, being one quarter the frame rate, and thus identifies the initiation of alternate frames displaying red/left oriented anaglyphic color channels.

The anaglyphic perception of red is weak and may be assisted by the ACB Stereo Color Contrast Filter not treating the red color records in the stereo pair. Or the filter's effect of adding cyan to the red color record of the images to be seen in the red phase and subtracting magenta from the red color record of images to be seen in the green-blue phase may be applied to a lesser extent or nth degree.

In such ways the anaglyphic perception of red to each eye in modulating anaglyph is enhanced.

In one preferred embodiment of this invention, the modulating motion anaglyph is processed by an ACB filter in which the ACB Modulating Stereo Color Contrast Filter is adjusting only the black color records (to assist the uptake of the color wash and for control of brightness.) This is followed by luminosity compression, color wash, blending and RGB levels contrast expansion. This presents an observer with field rate modulations of color contrasts that are perceived as balanced due to persistence of vision from the multiplexed display. This may be preferred, as the multiplexed anaglyphic color records appear more natural than when the full ACB Stereo Color Contrast Filter is used as it necessarily alters the color record. Or the effect of the full ACB Stereo Color Contrast Filter adjustment may take place to an nth degree.

Monochromatically perceived R/G-B to G-B/R modulations are produced where de-saturation of the color records of the stereo pair occurs instead of the selective color adjustments of the stereo colour contrast filter.

ITEM 4. FULL COLOR LEFT/RIGHT CONCURRENT VIEWING OF STROBE FREE STEREOSCOPIC RGRB CYCLE MODULATING ANAGLYPH. STILL OR MOTION.

A red, green, red, blue (RGRB) cycle of anaglyphic color channel orientations present a full color view to each eye via a multiplex of primary colors contained in modulating anaglyphic color channel displays while maintaining stereoscopic channeling. Viewing is achieved with electro-optic-anaglyphic viewers that switch through a red, green, red, blue cycle of filter presentations for each eye The filter colors presented before each eye are mutually 25% out of phase to enable anaglyphic cancellation and stereoscopic perception of four anaglyphic color channel orientations displayed in cycle.

Such viewing may be achieved with Variable Birefringence Polarized Interference Filters or any other such color modulating filter arrangement that may effect the required response. Such filters consist of filter stages used in series, with each stage providing independent analogue control of one additive primary color. Each filter stage can be switched between a primary color and a clear transmission state in response to trigger voltages.

With field recognition circuitry and wireless transmission of synchronizing signals sent to switching logic for electro-optic/anaglyphic viewers, the appropriate viewing filter presentations are synchronized with the modulating anaglyphic color channel displays.

An example of four anaglyphic color channel orientations that provide a multiplex of primary colors in an RGRB sequence is as follows;

1. Red left/Green right. 2. Green left/Red right. 3. Red left/Blue right. 4. Blue left/Red right.

When anaglyphically viewed through electro-optic/anaglyphic viewers which present each eye with a cycle of filters that synchronize their color presentations with the above sequence of anaglyphic colour channel orientations, each eye is presented with an RGRB sequence of primary colors in mutual anaglyphic opposition. The anaglyphic primary orientations 1,2,3 and 4 are repetitively presented for view in a sequence prepared at the field or frame rate or at any rate desired.

The red anaglyphic primary occurs at double the frequency to that of the green or the blue.

The preferred method to compensate for this is to reduce the luminance of the red color record in the anaglyphic displays by 50%. This does not effect the red color records ability for anaglyphic extinction. The resulting temporal multiplexing of the primary colors revealed from the RGRB cycle of anaglyphic color channels results in strobe free full colour stereoscopic perception.

Should an observer tilt their head, the extinction of the opposite eyes view is not degraded as it is with full color polarized viewing.

Viewing away from the monitor at ones surroundings through electro-optic/anaglyphic filters also results in full color perception with only a general reduction of brightness and therefore attention to details off screen is unhindered.

Production of RGRB Modulating Anaglyph Still or Motion

To produce such a still or motion picture by editing, an RIG-B to G-B/R modulating anaglyphic record is first produced as has been prior described above, An ACB Stereo Color Contrast Filter that treats only the black color record is used where the ACB treatment of black assists the uptake of the color wash and controls the brightness and density of the anaglyphic image when followed by luminosity compression and color wash via colour balance. The color records of the stereo pair are not filtered for color contrast to enable the subsequent anaglyphic color channel orientations produced to contain representations of primary color image planes from the stereo pair. An anaglyphic contrast balance of the orientations 1-4 is to be achieved via temporal multiplexing of the primary colors present in the RGRB anaglyphic cycle.

The R/G-B to G-B/R modulating anaglyphic record is then duplicated and the blue color record is then removed from one version resulting in an R/G to G/R modulating monochromatic anaglyphic record. The green colour record is removed from the other version resulting in an R/B to B/R modulating monochromatic anaglyphic record. The luminance or the output level of the red color records are reduced 50% to compensate for it's occurring at comparatively twice the frequency in the RGRB cycle.

An example of the RGB Levels removal of the green and of the blue color records and of the reduction by 50% of the red colour record follows.

R/G-B to G-B/R version 1.

RGB levels output. Red +128. Green +255. Blue. 0.

Resulting in a R/G to G/R modulation

R/G-B to G-B/R version 2.

RGB levels output. Red +128. Green 0. Blue +255.

Resulting in a R/B to B/R modulation

The two modulating filter treated pairs are then interpolated at half the rate of their modulation. This results in an RGRB cycle modulating anaglyphic record consisting of field or frame sequential anaglyphic orientations 1.Red/Green. 2 Green/Red. 3. Red/Blue. 4.Blue/Red.

When viewed as stills, the resulting individual anaglyphic orientations are monochromatic and are not contrast balanced. But as each eye is to receive the three primary colors contained in the anaglyphic colour channels in rapid succession via electro-optic/anaglyphic filters, an image of full color and contrast balance is perceived simultaneously by each eye due to persistence of vision blending the three primary colors together as with regular RGB color perception.

The resulting RGRB cycle modulating motion anaglyph is perceived stereoscopically and in full color to each eye when viewed through synchronized electro-optic/anaglyphic viewers.

Alternatively, a modulating RGRB cycle anaglyphic filter may be used to instantly render the stereo pair as a video stream of RGRB cycle anaglyphic color channel orientations as described below.

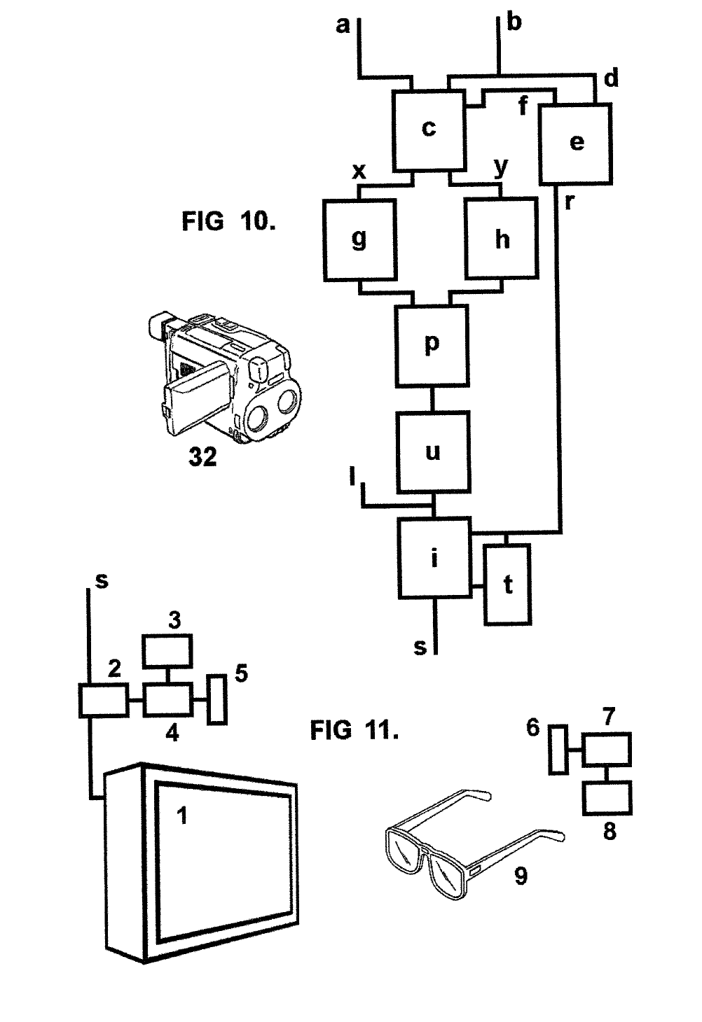

RGRB Cycle Modulating Anaglyphic Filter Refer to FIG. 10

For the instant production of a field rate RGRB cycle modulating anaglyphic record; a synchronized stereo pair 10a and 10b from the CCD'S of a stereoscopic video camera 10.32 or from any separate video image signals digital or analogue are directed by field recognition circuitry 10e and stereo switch 10c which are selected to allocate a field rate modulation of R/G-B to G-B/R orientation initiating with the R/G-B orientation applied from the first odd field detected as prior described above with reference to FIG. 9.

Along path 10x the red oriented ACB Filter treatments of the Stereo Color Contrast Filter, Luminosity Compression, and Color Wash take place at 10g. The formula and nature of the ACB Filter treatments have been prior described above.

Along path 10y the green-blue oriented ACB Filter treatments of the Stereo Color Contrast Filter, Luminosity Compression, and Color Wash take place at 10h. The formula and nature of the ACB Filter treatments have been prior described above.

Blending of the two filter paths 10x and 10y takes place at 10p. The nature of the blending has been prior described above.

The field recognition circuitry 10e also sends trigger signals 10r to a Red/Green/Blue levels removal filter/switch 10i, which operates at half the modulation rate. In response to the trigger signals 10r, frame rate switching between the removal of the blue color record and the removal of the green color record occurs at 10i. The sustained reduction of the output level of the red color record by 50% also occurs at RGB filter/switch 10i and this reduction remains constant throughout the accompanying switching between the removal of blue and the removal of the green color record. Such removal initiates with the removal of the blue color record from the same first odd field detected by the field differentiation circuit 10e when allocating an RIG-B orientation. This causes the first frame produced from the RGB contrast expander 10u consisting of odd field 1 R/G-B and even field 2 G-B/R to have it's blue color record removed by 10i resulting in orientation 1. Red/Green and orientation 2. Green/Red. Subsequently the second frame produced from 10u consisting of odd field 1 R/G-B and even field 2 G-B/R is caused to have its green color record removed by 10i resulting in orientation 3 Red/Blue and orientation 4 Blue/Red. The resulting video stream 10s is therefore field rate modulated from the first odd field detected as an RGRB modulating anaglyphic record of orientations 1. Red/Green, 2. Green/Red, 3. Red/Blue, 4. Blue/Red, in continuum.

The R/G-B to G-B/R modulating anaglyphic record produced from 10u is available externally as 101. Index generator 10t responds to field trigger signals 10r sent from field recognition circuitry 10e. Initiating with the first odd field detected by 10e, index pulse generator 10t issues index pulses to the outgoing video signal at 10i at a frequency one quarter that of the modulation rate, being half the frame rate, to coincide with the commencement of the selective removal of the blue color record by 10i that result in RGRB orientation 1 red/green. Thus the frames beginning with anaglyphic orientation 1 are differentiated from frames beginning with orientation 3 by the index signal.

The resulting field rate RGRB cycle modulating anaglyphic video stream 10s is then available for broadcast, recording, on line access, monitor display, or screen projection where anaglyphic orientations 1 and 3 may be displayed as the odd field lines and anaglyphic orientations 2 and 4 may be displayed as the even field lines. Such a modulating filter may be computer programmed as software or may be constructed as integrated circuitry or may be assembled from analogue colour selective filters, brightness and contrast filters and a video cross fader that are VSPI switched. An RGB image plane separator and switch may selectively remove the green and blue color records.

Variations

Should a frame rate modulation be selected, the field recognition circuit 10e sends frame initiation signals 10f to stereo switch 10c causing a frame rate modulation from the first frame detected. A frame initiation signal 10r is sent to RGB filter/switch 10i where the sustained 50% reduction of red and the alternate removal of blue and then green at half the frame rate occurs. Signal 10r is also sent to index generator 10t. Index generator 10t issues index pulses to the outgoing signal of RGB filter/switch 10k at a rate one quarter that of the modulation rate, being one quarter the frame rate, and thus identifies the initiation of frames displaying RGRB orientation 1 red/green with an index signal.

Other cycles of anaglyphic orientation are possible. For example, an RRGB cycle. A modulating anaglyphic filter as described above may select a field rate RRGB cycle as follows. Field recognition circuitry 10e and switch 10c are selected to allocate a frame rate modulation of R/G-B to G-B/R initiating with the R/G-B orientation from the first frame detected. In conjunction, the field recognition circuitry also allocates field rate color removal via RGB filter/switch of the blue colour record from the odd fields and the removal of green color record from even fields and the sustained 50% reduction of the red color record output. The resulting video stream 10s is therefore field rate modulated from the first odd field detected as an RRGB cycle anaglyphic record of orientations 1.Red/Green, 2.Red/Blue, 3.Green/Red, 4.Blue/Red, in continuum.

Monochromatic RGRB cycle modulating anaglyphic record may be produced where de-saturation of the color records of the stereo pair occurs instead of the selective color adjustments of the stereo colour contrast filter.

Wireless Transmission of the Synchronisation of RGRB Cycle Display Orientations with Electro-Optic Anaglyphic Viewer Presentations Refer to FIG. 11

When viewing RGRB cycle modulating anaglyphic record, there is an opportunity for the electro-optic anaglyphic filter presentations of green and blue to be 180 degrees out of phase despite the red/left anaglyphic colour channel orientations 1 and 3 always initiating on readily identifiable odd fields. Should the presentation be incorrect, the observer's perception of color would be muted. The green filter phase is not generous in the transmission of the blue color record. The green color record would pass generously through blue filter and the red color record would be unaffected. The anaglyphic extinction would also be unaffected.

By comparison an RRGB cycle viewed out of phase presents the opposing view to each eye.

A systematic method of synchronization is required.

An RGRB cycle modulating anaglyphic movie is displayed on a monitor screen 11.1 whether received from a camera, as a broadcast, on line feed, pre-recorded or live.

The index pulse and field differentiated signals are isolated from the RGRB modulated anaglyphic program 11s by a recognition circuit 11.2.

A field rate modulating anaglyphic program has index signals every two frames at the initiation of every other red/left oriented anaglyphic display. This frequency in relation to the field rate frequency is 1:4. This ratio causes the index/field differentiation circuit 11.2 to produce field-differentiated pulses representing the initiation of both odd and even fields along with the index signal.

A frame rate modulating anaglyphic program has index signals every four frames at the initiation of every other red/left oriented anaglyphic display. This frequency in relation to the field rate frequency is 1:8. This ratio causes the index/field differentiation circuit 11.2 to produce frame initiation pulses representing the initiation of odd fields and also produce the index signal. Thus the programs modulation rate is determined for transmission of synchronizing signals.

An oscillator 11.3 generates a radio frequency carrier signal and supplies it to a modulator 11.4 where the index and modulation rate signals are also received from 11.2. Modulator 11.4 supplies its resulting modulated carrier signal output to a frequency transmitter 11.5. The nature of the transmitter and the transmitted frequency may be radio or infrared or any other such suitable medium.

Signals representing the index and modulation rate signal are then transmitted to receiver 11.6. The nature of the receiver corresponds with nature of the transmitter. Where radio frequency is employed 11.6 is a radio receiver. Where infrared is employed 11.6 is a photo detector. Receiver 11.6 produces electric signals representing the index and modulation rate in response to the received transmission and supplies them to a demodulating circuit 11.7. The demodulating circuit extracts signals representing the index and modulation rate signals and supplies them to switching logic 11.8. Upon switching logic 11.8 receiving the signals, a sequence of trigger voltages 1-4 that correspond to viewing filter presentations 1-4 are cycled eventuating with presentation 1 in response to the index pulse and switching logic. Subsequent filter presentation cycles of 1-4 follow at a frequency governed by the modulation rate signals which accompany the index signal.

The Switching logic of such triggering voltages may be achieved using a switch that responds to the modulation rate signals and selects trigger voltages from between the outputs of two switches that respond at half the modulation rate. The first half rate switch is selecting between two trigger voltages that correspond to viewing presentations 1 and 3. The second half rate switch is selecting between two trigger voltages that correspond to viewing presentations 2 and 4. The voltages 1-4 are available from four resisters of differing values that are connected to a battery power supply (not shown).

In response to the incoming modulation rate signals, the modulation rate switch selects between the output of the first half rate switch to receive trigger voltages 1 or 3 and selects from the output of the second half rate switch to receive trigger voltages 2 or 4. This results in a cycle of trigger voltages 1-4.

Upon the index pulse occurring at the onset of anaglyphic display orientation 1, a resister samples the voltage being selected by the modulation rate switch. If the target voltage for presentation 1 is received, the selection is allowed to continue unaffected. If the target voltage for presentation 1 is not received, this inactivates the modulation rate switch for duration of one switching signal. This causes the modulation rate switch to lag behind until re-tested and allowed to continue unaffected and in sync'. This may be effected by a modulation rate circuit breaker that interrupts the modulation rate switches circuit. The longest lag till synchronization is thus 3 index cycles being 12 frames for a frame rate modulating program.

The receiver 11.6, de-modulating circuit 11.7, switching logic 11.8 and their battery power supply (not shown) are integrated in the viewing frame of the electro-optic/anaglyphic viewers 11.9. The power supply may be of any suitable lightweight battery/capacitor design such as an aerocapacitor.

The filter presentations 1-4 of the electro-optic/anaglyphic viewer 11.9 are thus synchronized with the anaglyphic colour channel orientations 14 displayed on monitor 11.1.

An RRGB cycle synchronization can also be achieved with the same system but is not cross compatible with RGRB cycle or R/G-B to G-B/R modulation.

R/G-B Transition Compatibility with RGRB Cycle

Both RGRB cycle and R/G-B transition electro-optic anaglyphic viewers will make viewable filter presentations for either of the modulating displays. An RIG-B transition electro-optic/anaglyphic viewer is caused to present red/left filter presentations during red/left anaglyphic displays in response to switching logic and will allow the transmission of RGRB cycle primary green and primary blue displays through its green-blue colour filter presentations. A monitor display of R/G-B to G-B/R modulating anaglyph is also viewable with RGRB cycle electro-optic anaglyphic viewers where the green-blue anaglyphic colour channels are sampled through the primary green and primary blue RGRB electro-optic/anaglyphic filter presentations. The construction of R/G-B transition and RGRB electro-optic anaglyphic viewers allows for identical circuitry except that in R/G-B transition circuitry the trigger voltages 2 and 4 are linked, as are the trigger voltages land 3

Field or Frame Rate R/G-B to G-B/R Modulating Anaglyphic Record Converted to RGRB Cycle

The following process may also be illustrated with reference to FIG. 11.

A broadcast, on line or pre-recorded field or frame rate R/G-B to G-B/R modulating program 11s is displayed on monitor 11.1. A field rate R/G-B to G-B/R modulating program has index signals every two frames at the initiation of every other red/left oriented anaglyphic display. This frequency in relation to the field rate frequency is 1:4. This ratio causes the index/field differentiation circuit 11.2 to produce index and field differentiated pulses representing both odd and even fields. A frame rate R/G-B to G-B/R modulating program has index signals every four frames at the initiation of every other red/left oriented anaglyphic display. This frequency in relation to the field rate is 1:8. This ratio causes the index/field differentiation circuit to produce frame initiation pulses representing the initiation of odd fields along with the index signal. Wireless transmission of the index signals and of signals representing the modulation rate are received by the switching logic of R/G-B transition electro-optic/anaglyphic viewers where the switching rate is determined by the signals representing the modulation rate. The incidence of the index pulses causes a sample of trigger voltages that either find the target voltage or cause the selection of trigger voltage to pause and then let synchronized switching continue.

Or the R/G-B to G-B/R modulating program may be optionally re-modulated for viewing with RGRB electro-optic/anaglyphic viewers.

This is achieved by an RGB color removal filter/switch that removes blue and then green at a frequency half that of the programs modulation rate which is determined by the index/field recognition circuit. Such switching between the removal of the blue and green colour records is accompanied by the sustained 50% reduction of the red color record and is initiated in response to the first index signal detected by the index/field recognition circuit. The index/field recognition and also the green/blue removal with reduction of red occur at 11.2.

As all of the index signals occur at the initiation of red/left anaglyphic displays, the half modulation rate action of removing the blue color record from an R/G-B and a G-B/R display results in RGRB orientations 1 red/green and 2 green/red. The removal of the green colour record for the next two modulations results in RGRB orientations 3 red/blue and 4 blue/red, and thus RGRB in continuum. The resulting field or frame rate RGRB cycle modulating anaglyphic program is displayed on monitor 11.1.

The index signals and signals representing the modulation rate are transmitted to the switching logic of the RGRB cycle electro-optic/anaglyphic viewers where the modulation signals determine the switching speed for the selection of trigger voltages between 1 or 3 and trigger voltages 2 or 4. The incidence of the index signal causes the status of trigger voltage to be sampled as has been prior described above. If the target voltage is correct the cycle continues unaffected. If the target voltage is incorrect the modulation rate switch lags for the duration of one switching signal until re-sampled and found in sync'. A cycle of synchronous filter presentations 1-4 then ensues. This results in the synchronized viewing of full color RGRB cycle modulating anaglyph from an on line, broadcast, pre-recorded or live R/G-B to G-B/R modulating anaglyphic program.

The compatibility of the two modulation modes enables production and consumer choices. Alternatively where the monitor 11.1 is a computer monitor, the RGB color filter/switch function of alternate removal of blue and green color records at half the modulation rate and the 50% reduction of the red colour record may be computer programmed as software so that a computer monitors display is caused internally to selectively display only the colors required.

An RGB colour removal filter/switch may also be constructed as integrated circuitry or from analogue color selective filters and an RGB image plane separator and a VSP responsive electronic switch may selectively remove the green and blue color records in response to switching logic.

ITEM 5. INTERACTIVE THREE DIMENSIONAL PERCEPTION OF CONCURRENT VERTICAL AND HORRIZONTAL PARALLAX VIA ANAGLYPHIC/LENTICULAR VIEWING OF STILL OR MOTION ANAGLYPHIC IMAGE-DISPLAYED AS PRINT.

Traditionally, lenticular arrays provide an autostereoscopic or unaided view of a 3D image by refracting light passing through a transparent lenticular sheet that is aligned and secured over a composite printed image. The uniform and vertically parallel corrugations that form the sheet behave as lenses to effect the presentation of vertical portions of the image focused under each corrugation. The portion revealed depends on the viewing angle. The composite image under the lenticular sheet consists of two or more separate images that are vertically interlaced. For a 3D image, two or more images of horizontal parallax are vertically interlaced sequentially and spatially so as to fit a representation from each view under each vertical lenticular corrugation such that the representations of each view are specific to the vertical zone under each lenticular corrugation.

As the corrugations act as refracting lenses, different strips of the vertically interlaced image are presented to each eye for view. This is due to the separation of the viewer's eyes enabling mutually varied viewing angles through the corrugations of the lenticular sheet.

A feature of this invention is that the principles of Anaglyphic and Lenticular viewing are combined where the images are anaglyphic and the lenticular array and the interpolation of images are instead horizontally oriented. Traditional red left or green-blue left viewing of printed anaglyphs enable perception of horizontal parallax to be perceived via color channels from a single display surface. When multiple anaglyphic images that represent graduations of vertically displaced stereoscopic views (VDSVs) are horizontally interlaced, sequentially and spatially, so as to fit a representation of each view under each horizontal lenticular corrugation that is specific to that horizontal zone in each anaglyphic image, then multiple upper and lower anaglyphic VDSVs are available for view. Multiple VDSVs may be captured by a bank of stereo cameras or may be selected as a sequence of stills from the vertical motion of one stereo camera. With such a capture, the camera may instead pan or observe a subjects motion. Alternatively a single lens camera may take a succession of images at regular intervals while in lateral motion alongside a subject or in rotation about a subject so that any two adjacent images then form a stereo pair. An anaglyphic/lenticular display of such printed stereo pairs will reveal a progressive sample of stereoscopic views of the cameras recording path.

The inclusion of more than twelve interpolated images for regular optically produced lenticular display is common. The display of multiple stereoscopic captures is then limited only by the number of interpolated VDSVs or the number of interpolated stereoscopic anaglyphic stills that will fit under each lenticular lens. Anaglyphic/lenticular print may be achieved with existing photographic and lithographic printed display of lenticular images where the images consist of anaglyphic VDSVs and where orientation of the interpolation of the VDSVs and the orientation of the lenticular lens is horizontal. However, fewer colors are available with CMYK mode. Printing in RGB mode produces better results as with LED printers. The interpolated images may be horizontally inverted and printed directly onto the under surface of a lenticular sheet. Multiple stereoscopic graduations of vertical parallax and or motion picture are perceived when such a lenticular image is viewed through anaglyphic gel.

Interactive Three Dimensional Perception of Concurrent Vertical and Horrizontal Parallax via Anaglyphic/Lenticular Viewing of Still or Motion Anaglyphic Image-Displayed on a Monitor

To capture such an image for monitor viewing, two separate VDSVs may be records of a still or moving image and represent upper and lower views. Ideally, four proportionally fixed recording perspectives simultaneously record a subject.

The upper and lower stereoscopic information available should be set to appear and interact within a vertically and horizontally correct quadrascopic window. The arrangement should be such that a correct stereo window interrelates between all six combinations of the four views. Considerations for stereo window placement are later discussed under item 6.

The four views of the quadrascopic set are processed into two separate anaglyphic records by way of the Anaglyphic Contrast Balance process described above where one anaglyphic record represents the upper view and the other represents the lower view. The two anaglyphic records are then interlaced and displayed on a flat monitor screen so that one of the stereoscopic views, preferably the lower view, is displayed only on the odd fields lines and the other stereoscopic view, preferably the upper view, is displayed only on the even fields display lines. Such field rate switching is referred to above where field recognition circuitry may allocate the lower anaglyphic view to the first odd field detected.

A lenticular array is secured in direct contact and in horizontal orientation over a flat monitor screen. The frequency or gauge of the lenticular lenses enable an odd field scan line and an even field scan line to be situated under each horizontal lens so that representations of the upper and lower views specific to each horizontal zone of the images fit under each horizontal lenticular lens.

This enables a choice of perceiving upper or lower anaglyphic VDSVs by viewing through color corresponding anaglyphic gels and raising or lowering ones viewing angle in relation to the display surface or by tilting the viewing surface to effect the same.

Production of Quadrascopic Anaglyph

To produce a Quadrascopic-anaglyphic record of fixed color channel and viewing orientation by editing; anaglyphic records of the upper and lower views are prepared as has been prior described above. The upper and lower views are then interpolated at the field rate with the lower view allocated to the odd field scans.

The lower and upper views are displayed under a lenticular sheet with a frequency of horizontal lenses such that each lens covers a single odd field scan line and a single even field scan line.

The lenticular screen reveals a bright anaglyphic record of concurrent horizontal and vertical parallax with a balanced and dynamic contrast with near total extinction of the opposing views that is perceived in color with spectral split when viewed through color corresponding gel.

The resulting Quadrascopic anaglyphic images may be of red left or green-blue left orientation, still or moving, to be viewed with colour complimentary gel presentation.

Alternatively, a Quadrascopic ACB Filter may be used to instantly render the two VDSVs into a single Quadrascopic video signal stream of fixed orientation as is later described.

Production of Quadrascopic R/G-B to G-B/R Modulating Anaglyph

To produce such a still or motion picture by editing, An R/G-B to G-B/R modulating anaglyphic record of both the upper and lower views are prepared as has been prior described above where they are modulated at the frame rate. This will enable a spectral split free view of both the upper and lower anaglyphic records.

The upper and lower frame rate R/G-B to G-B/R modulating anaglyphic records are then interpolated together at the field rate so that one of the modulating anaglyphic views (preferably the lower view) is displayed only on the odd field lines and the other modulating anaglyphic view (preferably the upper view) is displayed only on the even fields horizontal lines.

The lower and upper views are displayed under a lenticular sheet with a frequency of horizontal lenses such that each lens covers a single odd field scan line and a single even field scan line.

The Lenticular sheet then reveals either the upper or the lower stereoscopic view to an observer depending on their elevation of viewing angle or the tilt of the monitor screen when viewing through R/G-B transition electro-optic/anaglyphic filters.

The result is a bright anaglyphic record of concurrent horizontal and vertical parallax with a balanced and dynamic contrast with near total extinction of the opposing views that is perceived in an approximation of full color to each eye when viewed through electro-optic/anaglyphic/lenticular combination.

A printed quadrascopic image should be reproduced at a precision size to correspond with the gauge of the lenticular lenses.

Alternatively, a Quadrascopic ACB Filter may be used to instantly render the two VDSVs into a single stream of frame rate R/G-B to G-B/R Modulating Quadrascopic video signal as is later described.

Production of Quadrascopic RGRB Cycle Modulating Anaglyph

To produce such a still or motion picture by editing, the RGRB cycle modulating anaglyphic records of both the upper and lower views are each prepared as has been prior described above where the frequency of modulation is at the frame rate. This will enable full color viewing of both the upper and lower views. A field rate quadrascopic program reveals spectral split.

The two synchronized frame rate modulating anaglyphic records of the upper and lower views are then interpolated together at the field rate where the lower view is allocated to the odd fields and the upper view is allocated to the even fields to form a single record of frame rate RGRB cycle modulating anaglyphic color channel orientations 1,2,3,4.

The resulting Quadrascopic RGRB Cycle Modulating Anaglyph is displayed under a lenticular sheet with a frequency of horizontal lenses such that each lens covers a single odd field scan line and a single even field scan line.

The Lenticular array then reveals in full colour to each eye either the upper or the lower stereoscopic view, depending on the elevation of viewing angle or the tilt of the monitor screen, when viewing through electro-optic/anaglyphic filters.

Alternatively, a Quadrascopic ACB Filter may be used to instantly render the two VDSVs into a single stream of frame rate Quadrascopic RGRB cycle Modulating video signal as described below.

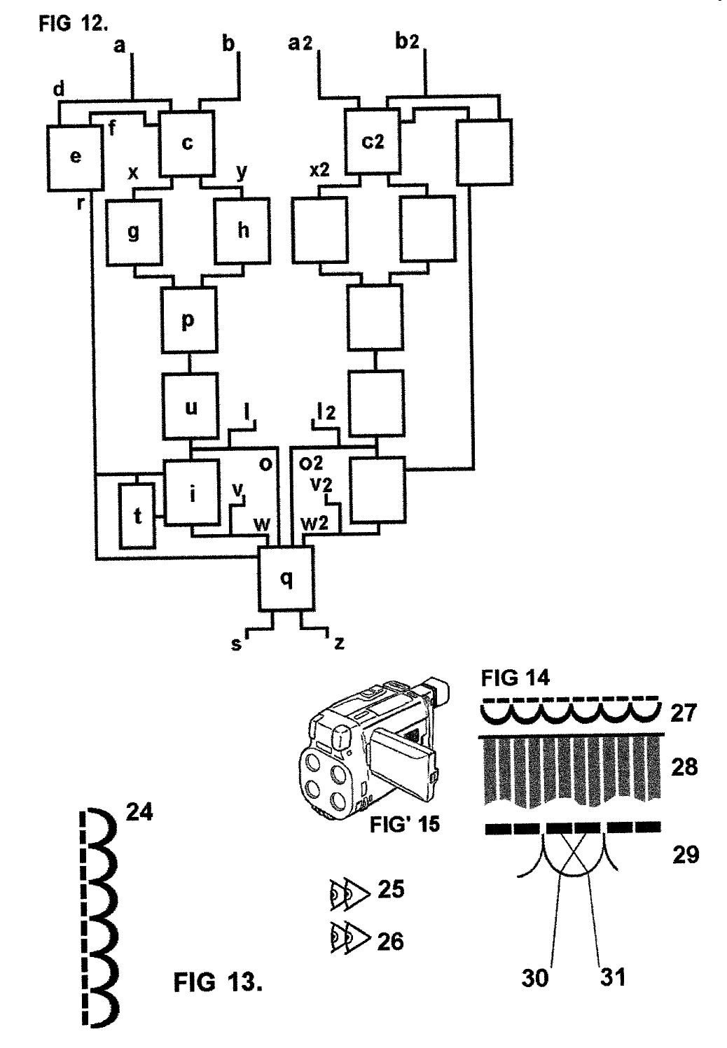

Quadrascopic ACB Filter refer to FIG. 12.

Enabling the instant production of both R/G-B to G-B/R modulating and RGRB cycle Modulating Anaglyphic records, the ACB Quadrascopic filter consists of two Modulating Anaglyphic Filters in tandem. One of the modulating filters is producing the anaglyphic record of the upper view and the other filter is producing the anaglyphic record of the lower view. The synchronized inputs of the upper left view 12a and the input of the upper right view 12b correspond with the synchronized inputs of the lower left view 12.a2 and the lower right view 12.b2 respectively. As the processes for the upper stereo pair corresponds directly to those of the lower stereo pair, the process for the lower stereo pair is inferred to avoid redundancy.

To enable instant R/G-B to G-B/R modulating and/or RGRB cycle modulating anaglyphic production, the upper stereo inputs 12a left and 12b right are filtered by an ACB Modulating Filter that is mutually switching its synchronized inputs between a red oriented filter path 12x and a green-blue oriented filter path 12y at the frame rate. The switching is governed by the field recognition circuit 12e and electronic stereo switch 12c. Either the left or right synchronized inputs may provide a video signal 12d to the field recognition circuitry 12e for discernment. Switch 12c responds to frame initiation trigger pulses 12f sent from field recognition circuitry 12e. Thus, the video streams of the upper stereo pair, 12a left and 12b right are caused to mutually switch at the frame rate between the red oriented path 12x and the green-blue oriented path 12y initiating with a red/left orientation from the first frame detected by 12e. The switching video inputs are further processed as follows: Along path 12x the red oriented ACB Filter treatments of the Stereo Colour Contrast Filter, Luminosity Compression and Colour Wash take place at 12g. The formula and nature of the ACB Filter treatments have been prior described above. Along path 12y the green-blue oriented ACB Filter treatments of the Stereo Color Contrast Filter, Luminosity Compression and Colour Wash take place at 12h. The formula and nature of the ACB Filter treatments have been prior described above.

Blending of the ACB Filter treated video from paths 12x and 12y take place at 12p. The formula and nature of this blend has been prior described above. RGB Contrast Expansion occurs at 12u. The nature of the expansion has been prior described above.

The resulting output of 12u is a frame rate R/G-B to G-B/R modulating anaglyphic record of the upper view and is available as an external output 12.1. This signal continues internally as 12o to electronic switch 12q and is also sent to RGB color removal filter/switch 12i.

The sustained reduction by 50% of the red colour records output level along with switching at half the modulation rate between the selective removal of blue and the selective removal of green occurs at RGB color removal filter/switch 12i. Switching between the removal of blue and green colour records occurs in response to frame initiation trigger pulses 12r that are generated by field recognition circuit 12e. RGB color removal filter/switch 12i initiates with the removal of the blue color record from the first frame detected by 12e. This causes the first frame produced by RGB contrast expander 12u of orientation R/G-B to have its blue color record removed by 12i resulting in RGRB orientation 1. R/G.

The second frame produced from 12u of the orientation G-B/R also has its blue color record removed by 12i resulting in RGRB orientation 2. G/R.

The third frame produced from 12u of orientation R/G-B now has its green color record removed by 12i resulting in RGRB orientation 3. R/B.

The fourth frame produced from 12u of orientation G-B/R also has its green color record removed by 12i resulting in RGRB orientation 4. B/R.

The resulting output of 12i is a frame rate RGRB cycle modulating anaglyphic record of the upper view and is available as an external output 12v. This signal continues internally as 12w to electronic switch 12q. The corresponding outputs of the Quadrascopic ACB Filter processed lower views include external output 12.12 which is a frame rate R/G-B to G-B/R modulating anaglyphic record of the lower view. This signal continues internally as 12.o2 to electronic switch 12q. 12.v2 is an external output of a frame rate RGRB cycle modulating anaglyphic record of the lower view. This signal continues internally as 12.w2 to electronic switch 12q. Index generator 12t responds to frame initiation trigger pulses 12r from the field recognition circuit 12e. Initiating with the first frame detected by 12e, index pulse generator 12t issues index pulses to the output of 12i at a frequency of one quarter the modulation rate that is determined by the frame initiation trigger pulses. These index pulses coincide with the commencement of the selective removal of the blue color record by 12i that result in RGRB cycle orientation 1 red/green.

Field rate electronic switch 12q is a dual switch responding to field trigger pulses 12r generated by the field recognition circuit 12e. Dual electronic switch 12q selects between upper anaglyphic record 12o and lower anaglyphic record 12.o2 at the field rate initiating with 12.o2. The resulting output 12s is a Quadrascopic R/G-B G-B/R modulating anaglyphic record for monitor display of the lower anaglyphic view as the odd field scan lines and the upper anaglyphic view as the even field scan lines.

Optionally and simultaneously, dual switch 12q also selects between upper view 12w and lower view 12.w2 at the field rate initiating with 12.w2 as determined by trigger pulse 12r. The resulting output 12z is a quadrascopic RGRB cycle modulating anaglyphic record for monitor display of the lower anaglyphic view as the odd field scan lines and the upper anaglyphic view as the even field scan lines.

The resulting video streams 12s and/or 12z are then available for broadcast, recording or on line access for quadrascopic monitor display.

Such a modulating filter may be computer programmed as software or may be constructed as integrated circuitry or may be assembled from analogue color selective filters, contrast filters and a video blender that are VSP switched. An RGB image plane separator and switch may selectively remove the green and blue color records.

The lower and upper views of either R/G-B to G-B/R or RGRB cycle modulation are displayed on the odd and even field lines of a monitor. Their anaglyphic color channel orientations modulate in phase at the frame rate and are displayed under a lenticular array with a frequency of horizontal lenses such that each lens covers one odd field scan line and also one even field scan line.

The Lenticular array then reveals either the upper or the lower stereoscopic view to an observer depending on their elevation of viewing angle, or by the tilt of the monitor screen, when viewing through electro-optic/anaglyphic filters. The viewing presentations of the electro-optic/anaglyphic viewers are synchronized with the anaglyphic display orientations as has been prior described above.

Alternatives.

For the production of Quadrascopic Anaglyphic record, still or motion with a fixed anaglyphic colour channel display orientation of red/left or green-blue/left for viewing with fixed color corresponding gel, the electronic switch 12c is inactivated. When inactivated, switch 12c has a resting state that permits the video inputs 12a and 12b directly through to the filter paths 12x and 12y without switching their passage. Switch 12q continues to switch only between inputs 12o and 12.o2 resulting in output 12s. Such inactivation results in the production of a Quadrascopic anaglyphic record of fixed orientation for monitor viewing via lenticular screen and regular viewing gel.

A quadrascopic strobe record for viewing via electro-optic shutter glasses may also be produced where interpolations are made of upper and lower stereoscopic views for display respectively onto even and odd field scan lines. For such an application the color altering functions of the quadrascopic ACB filters and blenders are all inactivated and the frame rate outputs of switches 12c and 12.c2 being 12x for the upper left and upper right views and 12.x2 for the lower left and lower right views are bussed directly through the inactivated filters etc to field rate switch 12q. Switch 12q then selects between 12x and 12.x2 for two left views of upper and lower elevation for display onto the even and odd fields for a first frame and then selects between 12x and 12.x2 for two right views of upper and lower elevation for display onto the even and odd fields for a second frame, in continuum. When viewed via synchronous frame rate electro-optic shutters, and depending on the observers viewing elevation in relation to the quadrascopic screen, either the left upper or left lower views are available to the left eye and are hidden from the right eye for duration of one frame. During the next frame the left eye's view is hidden and the right eye is permitted the upper or lower views.

LCD or liquid crystal filters and twisted nematic LCD's are well established.

Quadrascopic Monitor Viewing refer to FIG. 13

A Lenticular array with horizontal corrugations that each cover an odd and an even field scan line is fixed over the display surface of a flat LCD colour display screen so that an odd and an even field display line lay under each lenticular lens. An out of scale and enlarged cross section of a quadrascopic monitor screen surface is shown in FIG. 13.24.

The preferred display surface is a flat LCD screen as it provides a uniform substrate to enable the lenticular sheet to display consistent angles of diffracted light from the flat horizontal field lines displayed. The LCD screen's image occurs at the screen surface enabling immediate contact with the lenticular sheet placing the screen image at the focal point of the lenticular lenses. The pixel display of the LCD screen is suited as they are displayed with adequate horizontal isolation of the odd and even fields. The display screen may be constructed with a permanent horizontal lenticular viewing surface. Such a screen would also function adequately for viewing a regular program.

Depending on the elevation of view, either the upper or lower view of modulating anaglyphic movie can be perceived in 3D and colour.

Should an observer be closely located before a monitor, as is commonplace for computer operation, the resulting quadrascopic anaglyphic video display reveals stereoscopic details of vertical and horizontal parallax from the original scene.

An upper elevated viewpoint of the quadrascopic display as in FIG. 13.25 anaglyphically reveals the upper stereoscopic anaglyphic view displayed on the even field lines and a lower elevated viewpoint of the quadrascopic display as in FIG. 13.26 anaglyphically reveals the lower stereoscopic anaglyphic view displayed on the odd field lines. Observation along a continuation of vertical elevation reveals an alternation of upper and lower viewing zones.

If the anaglyphic views were prepared at the field rate, the resulting quadrascopic display would electro-optically reveal spectral split and so frame rate viewing with perception of full color to each eye is preferred. A frame rate display is also necessary for the perception of diagonal parallax.

Should a viewer rotate their view to the left, the left eye then sees the lower left view and the right eye sees the upper right view as in natural vision. Correspondingly should a viewer tilt his head to the right, the left eye sees the upper left view and the right eye sees the lower right view. This is also achieved with quadrascopic displays of fixed colour channel orientation.

As half of the display screen is viewed for either the upper or lower view and as that half is further halved because of Anaglyphic channeling, the available resolution of this embodiment may be considered to be one quarter of the standard 2D resolution. In compensation, the addition of vertical parallax gives an increase of spatial information and presence beyond 2D and beyond 3D viewing.

Field and Frame Rate R/G-B to G-B/R Quadrascopic Program Converted to RGRB Cycle Quadrascopic Program.

The process of converting an R/G-B transition Quadrascopic program into an RGRB cycle Quadrascopic program is identical to the conversion process for regular field or frame rate R/G-B to G-B/R conversion to RGRB cycle modulation as has been prior described above.

ITEM 6. THE INSTANT STEREOSCOPIC ANAGLYPHIC CAMERA. STILL OR MOTION.

A stereoscopic anaglyphic camera as in FIG. 10.32 may be constructed as a dual hybrid from two identical existing units. Such a camera may be a television or movie camera, a hand/cam or web/cam or a snapshot camera. A distance of 62mm between the lenses will correspond to the average inter-ocular separation of human vision, though any dimension of recording base could be utilized.

The capture of a stereo camera should result in an equivalence of frame size and focal length of the stereo pair's images and the alignment of their edges should be set to inter-relate as a stereo window through which the resulting stereoscopic image appears and is captured.

For monitor or television display, the stereo window should be set as if positioned before the subject causing the stereoscopic images to appear to originate their location from beyond the screen. This is achieved by a mutual convergence of the left and right views that is usually fixed at approximately two meters. The stereo window is determined by the common intersecting plane where the frame borders of the left and right views coincide. This plane is synonymous with the edges of the monitor screen.

Zoom progression should be coupled with a progressive extension of the placement of the stereo window, which is achieved by a progressive reduction of the mutual convergence of the two views. The rate at which the convergence reduces should diminish as the stereo window recedes.

For commercial or industrial applications, stereo cameras with larger lens separations and a more distant stereo window setting may be used especially for filming distant subjects so as to achieve a perception of depth. For large screen or cinema displays, the stereo window should be set close to infinity causing the stereoscopic images to appear to originate their location from before the screen. This enables the stereoscopic view of distant imagery to not exceed the audience's ability to register the resulting displacement of the stereo pair.

Motion exposures from a stereo camera's two laterally displaced views are received onto two separate CCD arrays enabling a stereo pair.

The electronic records of this exposure are then treated by the Anaglyphic Contrast Balance Filter process as has been prior described above; i.e. Stereo Colour Contrast Filter, Luminosity Compression, Colour Wash, Blend and Contrast Expansion.

Choice of field or frame rate capture and selective ACB Stereo Color Contrast filter options and mode of modulation and optional two-dimensional playback or conversion provide the operator with useful features. A screen monitor image is revealed on a viewfinder or LCD screen of an anaglyphic display available for recording, external display, on line transfer, print, etc. The camera may both capture the stereo pair and produce the anaglyphic record or just capture the stereo pair for transfer to a computer for processing. Or the processing may be done following internal storage of the stereo pair.

Production of anaglyphic still images for print or isolation from an anaglyphic motion picture are available as progressive scans from established frame grabber methods.

A stereo movie camera utilizing a Modulating ACB Filter of FIG. 10 as prior described above would optionally enable instant modulating anaglyphic footage for recording, monitor display, online transfer or broadcast. Such anaglyphic modulation may be R/G-B to G-B/R or RGRB cycle modulating anaglyphic record. Recording via line inputs enables anaglyphic processing of separate unrelated image records that need not be stereoscopic. By-pass of the ACB process is easily achieved for recording of sequential stereoscopic strobe. Incorporating the optional function of synchronous RGB color removal, playback of anaglyphic record may be optionally converted for regular two-dimensional display in color for unaided viewing.

A snapshot camera also exposes two laterally displaced views onto two separate CCD arrays enabling a stereo pair. Upon processing the anaglyphic image as has been prior described, an LED printer head incorporated in the instant anaglyphic digital camera translates the bits of image data into red, green and blue light that exposes instant film using established instant photographic methods. An instant anaglyphic photograph is then revealed, either monochromatic or in color with spectral split.

The Instant Quadrascopic Anaglyphic Camera. Still or Motion.

A Quadrascopic camera as in FIG. 15 may be constructed as a hybrid from four existing units. The considerations discussed above for stereo cameras also apply to the Quadrascopic camera. However the inter-relation of the four frames for the placement of the quadrascopic window and zoom control should take into account all six stereo pair combinations available between the four separate views.

A typical and realistic Quadrascopic base near that of natural vision would involve recording points at the corners of a 62 mm square, though any dimension of recording base could be utilized.

A Quadrascopic camera exposes two upper and two lower views so that each view is received onto a separate CCD enabling a quadrascopic set consisting of two stereo pairs. These are internally processed by ACB filters as has been prior described above with reference to FIG. 12 into upper and lower synchronous frame rate motion anaglyphic records.

Field rate switching between the lower and upper anaglyphic records provides a video stream allocating the lower anaglyphic display onto the odd field scans and the upper anaglyphic record onto the even field scans enabling perception of concurrent vertical and horizontal parallax via anaglyphic/lenticular combination. The view screen of the camera is accordingly quadrascopic screen with a lenticular array integral with the LCD display surface. The camera may both capture and produce the quadrascopic anaglyphic record or just capture the quadrascopic views for transfer to a computer for processing. Or the processing may be done following storage of the anaglyphic record.

A Quadrascopic movie camera utilizing a Quadrascopic ACB Filter as has been prior described above would enable instant modulating anaglyphic footage for recording, monitor display, online transfer or broadcast. Such Quadrascopic anaglyph may be of R/G-B to G-B/R or RGRB cycle modulating record or the Quadrascopic record may be of a fixed anaglyphic color channel orientation for viewing through color corresponding anaglyphic gels. Where RGRB Quadrascopic record is being produced, switching to an R/G-B to G-B/R Quadrascopic record is also simultaneously and optionally available as well as separate R/G-B to G-B/R and RGRB cycle records for both the upper and lower views. Recording via line inputs enables quadrascopic anaglyphic processing of separate unrelated image records that need not be stereoscopic.

Upper and lower stereophonic audio fields may be allocated to the Quadrascopic record to enable a periphonic sound track.

Production of anaglyphic still images or isolated from a quadrascopic motion record for print are available as progressive scans from established frame grabber methods.

A snapshot quadrascopic camera also exposes two vertically displaced views onto four separate CCD arrays enabling a quadrascopic set. Upon processing the anaglyphic image as has been prior described, the image is then horizontally inverted. An LED printer head incorporated in the instant anaglyphic camera translates the bits of image data into red, green and blue light that exposes instant film, using established instant photographic methods, directly onto the underside of a precision aligned lenticular sheet. An instant quadrascopic photograph is then revealed, either monochromatic or in color with spectral split.

ITEM 7. ALTERNATIVE 2D USE OF TWO AND FOUR CHANNEL SEPARATION.

Two separate and independent 2D programs or presentations of information, script or images, still or motion, may be anaglyphically processed and thus color coded and presented on a single viewing surface as an anaglyphic record of fixed viewing orientation or as a modulated display.

When both eyes view through filters of the same color, anaglyphic channeling will reveal only the images or information colour coded in the colour corresponding anaglyphic channel. A choice of viewing between the two concurrent programs is then determined by the selection of a colored viewing filter that may instead cover the monitor screen for unaided viewing.

For the isolation of either of two unrelated visual channels from a modulating program, electro-optic/anaglyphic viewers are required to synchronously present colors in unison that correspond to the modulating color channel selected for viewing. Or a screen size electro-optic anaglyphic filter element may instead cover the monitor screen for unaided viewing.

Alternatively the anaglyphic program may be converted by the selective removal of color or colors that represent one of the anaglyphic color channels to reveal a display of the program of choice without the need of any viewing filter.

An R/G-B to G-B/R modulating anaglyphic record consisting of two separate unrelated programs may be selectively addressed by an RGB filter/switch that intercepts the modulating image signal to selectively and synchronously remove the color channels in which one of the modulating programs is contained. For example, the red color record and then the green-blue color record are removed at the modulation rate in continuum to reveal only the remnant anaglyphic program as a multiplex of modulating colors that are perceived as a color program without strobe. The choice of program for unaided 2D viewing is determined by the phase of color removal.

An RGRB cycle modulating anaglyphic record enables the choice of two concurrent programs each in full color from a selection of synchronous color channel removal. Selective color removal via an RGB filter/switch strips the RGRB cycle anaglyphic record of one modulating anaglyphic color channel leaving the program of choice contained within the remnant colour channels.

The selective removal of a cycle of RGRB from the first index signal detected in an RGRB modulating program causes a removal of the red color record from RGRB orientation 1 resulting in the anaglyphic color channels red/green becoming green alone. Subsequent synchronized RGRB colour removal at a rate that of the programs modulation rate results a multiplex of GRBR (green, red, blue, red) without anaglyphic opposition and is perceived unaided as a color program. The choice of program is determined by the RGB color removal filter/switch operating comparatively 25% out of phase initiating as RGRB or GRBR from the detection of index signal to enable unaided 2D viewing of either of the two programs contained within the modulating display. Compensation for reduced image brightness can be achieved upon display.

Switching logic for R/G-B to G-B/R modulating colour removal via RGB filter/switch requires the identification of index and field differentiated signals where the de-modulation rate is determined from the ratio between field and index signals detected. An observer selects from between two target values that assign the phase of color removal starting point so that either red or green and blue is removed from index detection. At the incidence of the index signal a resister samples a voltage that accompanies each color removal and if the target voltage is not detected the phase of color removal is arrested for a duration of one modulation and is then found in sync' at subsequent index samples.

Optionally an R/G-B to G-B/R modulating program may be converted to RGRB cycle prior to a selection of 2D conversion.

For an RGRB cycle color removal via ROB filter/switch, the observer selects a target voltage value assigned to the initiating color in the cycle of color removal. At the incidence of the index signal a resister samples a voltage that accompanies each color removal and if the target voltage is not detected the phase of color removal is arrested for a duration of one modulation until found in sync' so that either a cycle of RGRB or GRBR color removal is initiated from the incidence of the index signal.

Such a color removal filter/switch may be computer programmed as software so that a computer monitors display is caused internally to selectively display only the colors required so as to reveal the program of choice. Or a color removal filter/switch may be constructed as integrated circuitry or may be assembled from analogue colour selective filters. An RGB image plane separator and a VSP responsive electronic switch may selectively remove the red, green or blue colour records in response to switching logic.

Modulating Anaglyphic 3D Conversion for 2D Unaided Viewing.

The process of isolating one program from within a modulating anaglyphic display as has been described above will also convert a filter viewed modulating anaglyphic 3D program into a 2D program for unaided viewing in full color and at the display rate of the originating display. Compensation for image brightness can be achieved upon display. Two-dimensional compatibility has frequently been cited as a stumbling block for three-dimensional viability. Where an RGB filter switch is a computer program function, an anaglyphic 3D program then becomes viable beyond such concern as optional conversion to 2D for monitor viewing is then readily accessible and may then also convert to display in black and white.

Such de-modulation/conversion as described above also applies to quadrascopic programs so that the upper and lower viewing elevations may if desired each present two separate and independent channels of information or images for unaided viewing. This enables a choice of unaided viewing of four concurrent programs available in full colour at the frame rate from one signal source via the selection of viewing elevation and the phase of the color removal filter/switch. Or the conversion of two separate stereoscopic programs displayed for upper and lower quadrascopic viewing may be converted for unaided two-dimensional viewing.

Many variations of coded viewing are available. The four channels available may also display two separate programs of two-dimensional vertical parallax where a colour removal filter/switch enables the choice of program and the viewing elevation enables the choice of upper or lower perspective. This configuration enables an autostereoscopic presentation as is described below.

ITEM 8. THE SELECTION BETWEEN TWO AUTOSTEREOSCOPIC COLOR PROGRAMS FROM ONE IMAGE SIGNAL VIA ANAGLYPHIC/LENTICULAR METHOD refer to FIG. 14.

A quadrascopic modulating anaglyphic program is presented on a monitor that is rotated 90 degrees to vertically display odd and even field scans under a vertically oriented lenticular array enabling a selective choice between the display of two separate 3D programs that are viewed unaided in color from one image signal. This is achieved where two left views of two 3D programs are processed into a frame rate modulating anaglyphic record for display onto the even field scan lines and the two right views that have also been processed into a frame rate modulating anaglyphic record are displayed onto the odd field scan lines. The lenticular lenses 14.29 enable visual channeling of the two anaglyphic displays via diffraction, however as the display is rotated 90 degrees the channeling is of a stereoscopic left-right nature rather than an up-down nature.

Where a quadrascopic monitor is rotated 90 degrees to the left, unaided observation for the left eye along line of sight 14.30 reveals the modulating anaglyphic display of the left views displayed on the even field lines and unaided observation for the right eye along line of sight 14.31 reveals the modulating anaglyphic display of the right views displayed on the odd field lines. The selection of a synchronized cycle of color removal via RGB filter/switch, as has been prior described above, enables an autostereoscopic choice between the two 3D programs in full color.

The capture of images for an autostereoscopic anaglyphic program is achieved with a stereo camera's supply of two separate and unrelated three -dimensional programs. However, the field scan is required to be rotated 90 degrees and so two separate rotated monocular cameras are more immediately accessible. Or a quadrascopic camera can supply an autostereoscopic program of vertical and horizontal parallax by being accordingly rotated 90 degrees during operation.

The production of such an image is achieved via the processes prior described above for quadrascopic modulating anaglyph except that the two left stereoscopic views are processed into an anaglyphic record, as are the two right views.

Where the quadrascopic camera is rotated 90 degrees to the left for image capture, the modulating anaglyphic record of the left views (being the upper views of the rotated quadrascopic camera) are allocated to the even field scans. The modulating anaglyphic record of the right views (being the lower views of the rotated quadrascopic camera) are allocated to the odd field scans. The quadrascopic monitor is rotated 90 degrees to the left accordingly for image display.

Alternatively should a quadrascopic camera may be rotated 90 degrees to the right during operation, the quadrascopic monitor is accordingly rotated 90 degrees to the right for image display.

The presentation of the choice between autostereoscopic programs representing upper and lower views is achieved with an RGB colour removal filter/switch that is synchronized by switching logic as prior described above in item 7 where a selection of the phase of color removal determines the program to be revealed and may be chosen by a remote means by selecting the target voltage value of the switching logic. The observer should remain central to the monitor display to receive correct stereoscopic channeling from the lenticular array.

The above embodiments are exemplary and are not to be construed as limiting to the present invention. Many alternatives, modifications and variations will be apparent to those skilled in the art. It should be appreciated that there are many variations and applications relevant to this invention across various fields of technology. The scope of this invention should not be considered as limited merely by these applications being absent from this application.

I claim:

1. Anaglyphic production method for anaglyphic record, still or motion, image or text, in RGB format by either digital or non-digital means in whole or in part including steps of;
a. isolating any two separate records of image or text and or synchronizing the images of a stereo pair to achieve an image pair that consists of a first image or images and a second image or images;
b. effecting selective color filter treatments to the color records of a first image of step a, to enable contrasts from the whole spectrum to be perceived anaglyphically from within the part spectrum of an assigned anaglyphic color channel saturation and enable perception of an anaglyphically viewed contrast balance with the selective color filter treated image or images of step c and where such selective color filter treatments are applied to either individual color records or to the entire color record to the nth degree and if applied are of custom values so as to compensate for or to compliment later treatment options of anaglyphic colour channel saturation of step g or step i,
c. effecting selective color filter treatments to the color records of a second image of step a, to enable contrasts from the whole spectrum to be perceived anaglyphically from within the part spectrum of an assigned anaglyphic color channel saturation and enable perception of an anaglyphically viewed contrast balance with the selective color filter treated image or images of step b and where such selective color filter treatments are applied to either individual color records or to the entire color record to the nth degree and if applied are of custom values so as to compensate for or to compliment later treatment options of anaglyphic color channel saturation of step h or step i;
d. effecting selective color filter treatments for control of increasing the brightness in the resulting anaglyphic image by selectively increasing the saturation of the black color records of the image pair to the nth degree either instead of or as part of the selective color filter treatments of steps b and c and effecting control of decreasing the brightness in the resulting anaglyphic image by selectively decreasing the saturation of the black color records of the image pair to the nth degree either instead of or as part of the selective color filter treatments of steps b and c;
e. effecting an optional de-saturation of the color records of the image pair instead of the selective color filter treatments of steps b and c;
f. effecting the elimination of ghosting of the resultant anaglyphic record with the reduction and or compression of the luminosity of the image pair executed pre or post the selective color filter treatments of steps b, c, and d and prior to the colour channel saturation treatments of steps g and h;
g. effecting a first anaglyphic color channel saturation via color balance filter applied to a first image to be viewed through a first colored filter resulting in an anaglyphic colour channel saturation that is mutually a spectral opposite to the colour channel saturation treated images of step h;
h. effecting a second and third anaglyphic color channel saturation via color balance filter applied to a second image to be viewed through a second colored filter resulting in an anaglyphic color channel saturation that is mutually a spectral opposite to the colour channel saturation treated images of step g;
i. as an alternative to the luminosity compressions of step f and the color channel saturations of steps g and h; effecting an anaglyphic color channel saturation to the selective colour filter treated image pair by control of RGB levels output values via levels or curves;
j. effecting a blending the image pair as a single record so as to reveal equal representations of the image pair in the resulting luminosity compressed anaglyphic composite image;
k. effecting a maximization of contrasts of the red, green and blue color records of the luminosity compressed anaglyphic composite image resulting in a contrast expansion of the anaglyphic color channels contained therein,

2. Apparatus for the display of anaglyphic record produced in accordance with the anaglyphic production method as claimed in claim 1, the apparatus comprising;
a. anaglyphic record produced in accordance with claim 1 of fixed color channel orientation that may be sent or received on-line, stored and reproduced from a recording medium and broadcast;
b. a monitor or projection screen display or other such display device of RGB format for the display of two anaglyphic colour channels that consist of more than two color saturations and represent still or motion anaglyphic record;
c. a printing system, machine or device, photographic or lithographic of RGB format for the display two anaglyphic color channels that consist of more than two color saturations and represent still anaglyphic record as print;
d. anaglyphic filter viewing gels of single frequency and of neutral viewing orientation that enable the selective transmission of a colour corresponding anaglyphic color channel display to an observer or;
d. a selective color record removal means to enable a selected anaglyphic color channel display to an observer;
f. anaglyphic filter viewing gels of opposing spectral frequencies and of fixed viewing orientation that correspond to the anaglyphic color channels.

3. Anaglyphic record produced in accordance with the anaglyphic production method of claim 1, that may exhibit;
a. still image as print perceived stereoscopically as three-dimensional and being monochromatic or colored image with balanced contrasts from the whole color spectrum within each anaglyphic color channel perceived via anaglyphic filter means with spectral split and where individual color channels being unrelated or interrelated are perceived as two-dimensional with contrasts from the whole color spectrum via single frequency filter;
b. monitor or projection display of still or motion anaglyphic record perceived stereoscopically as three-dimensional being monochromatic or colored image with balanced contrasts from the whole color spectrum within each anaglyphic color channel perceived via anaglyphic filter means with spectral split and where individual color channels being unrelated or interrelated are perceived as two-dimensional with contrasts from the whole color spectrum via single frequency filter;
c. the monitor or projection displays of exhibit b viewed unaided as two-dimensional with contrasts from the whole color spectrum present in either color channel via color removal RGB filter/switch.

4. Modulating anaglyphic color channel display production method for still or motion modulating anaglyphic record in RGB format by either digital or non-digital means in whole or in part, manual or automated, where two anaglyphic color channel displays which contain more than two color saturations and represent visual records, modulate between two anaglyphic display orientations so that at any instant during either an odd or even field scan more than two color saturations are displayed with a first color saturation as one anaglyphic channel and second and third color saturation as the opposing anaglyphic color channel including steps of;
a. isolating any two separate records of image or text or isolating and or synchronizing the images of a stereo pair to achieve an image pair that consists of a first image or images and a second image or images and alternating the image pair between two anaglyphic display processes or orientations at any rate selected to establish a modulation rate;
b. effecting selective color filter treatments to the color records of a first image of step a, to enable contrasts from the whole spectrum to be perceived anaglyphically from within the part spectrum of an assigned anaglyphic color channel saturation and enable perception of an anaglyphically viewed contrast balance with the selective color filter treated image or images of step c and where such selective color filter treatments are applied to either individual color records or to the entire color record to the nth degree and if applied are of custom values so as to compensate for or to compliment later treatment options of anaglyphic color channel saturation of step g or step i;
c. effecting selective color filter treatments to the color records of a second image of step a, to enable contrasts from the whole spectrum to be perceived anaglyphically from within the part spectrum of an assigned anaglyphic color channel saturation and enable perception of an anaglyphically viewed contrast balance with the selective color filter treated image or images of step b and where such selective color filter treatments are applied to either individual color records or to the entire color record to the nth degree and if applied are of custom values so as to compensate for or to compliment later treatment options of anaglyphic color channel saturation of step h or step i;
d. effecting selective color filter treatments for control of increasing the brightness in the resulting anaglyphic image by selectively increasing the saturation of the black color records of the image pair to the nth degree either instead of or as part of the selective colour filter treatments of steps b and c and effecting control of decreasing the brightness in the resulting anaglyphic image by selectively decreasing the saturation of the black color records of the image pair to the nth degree either instead of or as part of the selective color filter treatments of steps b and c;
e. effecting an optional de-saturation of the color records of the image pair instead of the selective colour filter treatments of steps b and c;
f. effecting the elimination of ghosting of the resultant anaglyphic record with the reduction and or compression of the luminosity of the image pair executed pre or post the selective color filter treatments of steps b and c and prior to the colour channel saturation treatments of steps g and h;
g. effecting a first anaglyphic color channel saturation via color balance filter applied to the image or text to be viewed through a first colored filter resulting in an anaglyphic color channel saturation that is mutually a spectral opposite to the colour channel saturation treated images of step h;
h. effecting a second and third anaglyphic color channel saturation via color balance filter applied to the image or text to be viewed through a second colored filter resulting in an anaglyphic color channel saturation that is mutually a spectral opposite to the colour channel saturation treated images of step g;
i. as an alternative to the luminosity compressions of step f, and also the color channel saturations of steps g and h; effecting the anaglyphic color channel saturations of steps g and h by control of RGB levels output values via levels or curves;
j. effecting a blending the image pair into a single record so as to reveal equal representations of the image pair in the resulting luminosity compressed anaglyphic composite image;
k. effecting a maximization of contrasts of the red, green and blue color records of the luminosity compressed anaglyphic composite image resulting in a contrast expansion of the anaglyphic color channels contained therein;
l. effecting the application of index or synchronizing signals or pulses to the incidence of the modulation rate at a consistent frequency;
m. optionally effecting a selective and alternate removal of second and third colour saturation assignments from the contrast expanded anaglyphic color channels of step k in a cycle of consistent frequency so that at any instant during an odd or even field scan only two color saturations are present with one color saturation as each anaglyphic color channel and initiating such effect at the incidence of synchronizing signal detection and;
n. optionally and in conjunction with step m, effecting a sustained reduction of brightness or output level of the luminosity of a first color saturation assignment proportionate to its relative over-inclusion in the resulting cycle of modulating colour channel orientations;
o. optionally, where there were more than two image pairs of step a, interpolating the anaglyphic records of the two image pairs together at half the modulation rate;
p. optionally, selectively removing a color record or a cycle of color records selected for removal that corresponds to and or synchronizes with a color record or a cycle of modulating color records that anaglyphically contain one or more visual channels of image or text to isolate a separate image record;
q. optionally, interpolating together the isolated image pair of step a, at a first consistent frequency as a first interpolated record and where there are two isolated image pairs of step a, interpolating together a second image pair of step a, at a first consistent frequency as a second interpolated record and then interpolating together the first and second interpolated records at a frequency half that of the first consistent frequency for viewing via electro-optic shutters.

5. Modulating anaglyphic color channel display produced as claimed in claim 4 that exhibit;
a. still or motion interrelated image or text perceived stereoscopically as three-dimensional with balanced color contrasts from the whole spectrum either as monochromatic or as color record simultaneously and continuously by both eyes from a multiplex of anaglyphic color channels via synchronized and color corresponding electro-optic/anaglyphic means;
b. the image from either visual channel of still or motion exhibit a, perceived unaided as monochromatic or as color record and two dimensional via a modulation of color record removal synchronous with an opposing modulating color channel;
c. alternations between left and right views for viewing via electro-optic shutters.

6. Modulating anaglyphic color channel display production method as claimed in claim 4 where four anaglyphic display orientations are optionally produced that modulate in a cycle as two anaglyphic channels so that at any instant during either an odd or even field scan display only one of the second or third colour saturation assignments of anaglyphic colour channels are present in the anaglyphic display and anaglyphically oppose the first colour saturation assignment and where the luminosity of the first color saturation assignment is reduced proportionate to its relative over-inclusion in the resulting cycle of modulating color channel orientations.

7. Modulating anaglyphic color channel display as claimed in claim 6 that exhibits;
a. still or motion interrelated image or text perceived stereoscopically as three-dimensional with balanced color contrasts from the whole spectrum either as monochromatic or as full color record simultaneously and continuously by both eyes from a multiplex of primary color image planes contained in anaglyphic primary colour channels via synchronized and color corresponding electro-optic/anaglyphic means;
b. image from either visual channel of still or motion exhibit a, being unrelated or interrelated perceived unaided as monochromatic or as full color record and two dimensional via a modulation of color removal synchronous with an opposing modulating color channel.

8. Apparatus for the display of modulating anaglyphic record produced in accordance with the modulating anaglyphic color channel display production method as claimed in claim 4, the apparatus comprising;
a. modulating anaglyphic record as claimed in claim 4 that may be sent or received on-line, stored and reproduced from a recording medium and received as broadcast;
b. a first power supply means enabling a signal detection means for the interception of the modulating program of step a, for the detection of synchronizing signals and field differentiated signals to determine the programs modulation rate and accordingly produce signals as representations of the modulation rate for transmission and also for the optional system of step c;
c. an optional color removal means to occur either in production or in post production for a conversion from a mode of modulation of two anaglyphic display orientations to a mode of modulation of four anaglyphic display orientations by effecting a selective and alternate removal of second and third color saturation assignments from the intercepted modulating anaglyphic record of step b in a cycle of consistent frequency and initiating such effect at the incidence of synchronizing signal detection;
d. optionally and in conjunction with optional step c, a selective color luminance reducing means effecting a sustained reduction of brightness or output level of luminosity of a first color saturation assignment proportionate to it's relative over-inclusion in the resulting cycle of four modulating colour channel orientations;
e. a display means for the display of modulating anaglyphic colour channels in RGB format on a monitor or a projection screen or other such RGB display device;
f. a means for the transmission of signals representing synchronizing signals and signals representing the modulation rate via radio, optical or any suitable medium to a receiving means incorporated with electro-optic/anaglyphic viewing filters;
g. a second power supply means enabling a receiving means to receive a transmitted carrier signal and to detect and re-generate signals representing synchronizing signals and signals representing the modulation rate for their delivery to a switching logic means;
h. a switching logic means for the determination and selection of trigger voltages for the synchronization of electro-optic/anaglyphic filter presentations with anaglyphic colour channel displays;
j. electro-optic/anaglyphic filters consisting of a pair of electro-optic light modulating filter elements that respond to the synchronizing voltage selection of switching logic of part h and present transitions between two filter presentations of anaglyphically opposing hues that together allow the transmission of three color saturations with a transmission of a first colour saturation through one filter and a transmission of second and third color saturations through the opposing filter or;
k. electro-optic/anaglyphic filters consisting of a pair of electro-optic light modulating filter elements that respond to the synchronizing voltage selection of switching logic of part h and present transitions between four filter presentations of anaglyphically opposed hues and where each filter element enables three color transmitting filter states that each allow the transmission of one saturated primary color where a first color filter is consistently and alternately presented for either visual channel throughout all four presentations with the second and third colour filter saturations alternately opposing at equal frequency;
l. as an unaided two dimensional alternative to electro-optic parts j and k, a modulating color record removal means that responds to the synchronizing voltage selection of the switching logic of part h to effect a modulation of color removal synchronous with a selected modulating color channel.

9. A printed anaglyphic/lenticular production method, digital or non digital in whole or in part, manual or automated, for the production of multiple concurrent and interactive anaglyphic visual channels in RGB format on a printed surface, including steps of;
a. the production method for anaglyphic image or text as claimed in claim 1 applied to multiple image pairs resulting in multiple anaglyphic images of fixed viewing orientation;
b. horizontally interpolating anaglyphic images via optical, digital or manual assembly means at a frequency such that the interpolated representations of each of the anaglyphic images are specific to horizontal zones that will fit under each corresponding horizontally oriented lenticular lens of step c;
c. a horizontally oriented lenticular lens array that is secured over the horizontally interpolating anaglyphic images of step b so that the anaglyphic image representations specific to each horizontal zone fit under each lenticular lens, or correspondingly applying the interpolated anaglyphic composite image to the undersurface of the lenticular array.

10. Printed anaglyphic/lenticular image display produced in accordance with the production method as claimed in claim 9 where the interpolated anaglyphic images exhibit;
a. multiple records of unrelated image or text from each color channel and perceived two-dimensionally with contrasts from the whole spectrum from within either anaglyphic color channel via single filter anaglyphic means;
b. multiple records of interrelated image or text specific to each color channel displaying two concurrent two-dimensional records of motion perceived with contrasts from the whole spectrum from within either anaglyphic color channel via single filter anaglyphic means;
c. multiple unrelated stereoscopic views perceived horizontally or diagonally as three-dimensional and either as monochromatic or colored with spectral split via color corresponding anaglyphic filters;
d. multiple interrelated stereoscopic views perceived with concurrent horizontal and vertical parallax and or motion and either as monochromatic or colored with spectral split via color corresponding anaglyphic filters.

11. Apparatus for the display of anaglyphic/lenticular images produced in accordance with the production method as claimed in claim 9, the apparatus comprising of;
a. interpolated anaglyphic printed images produced as claimed in claim 9 that may be sent or received on-line, stored and reproduced from a recording medium;
b. lenticular sheet consisting of an array of lenticular lenses of suitable pitch or frequency that enable an interactive visual channeling of images, text or other such visual matter contiguous with it's underside via refraction;
c. a printing means, system, machine or photographic device, LED, RGB lithographic or any other such printing system of RGB format for the reproduction of two anaglyphic color channels representing multiple anaglyphic still or motion visual records as print;
d. anaglyphic filter viewing gels of single filter frequency that correspond to a selected anaglyphic color channel and or anaglyphic filter viewing gels of fixed viewing orientation and of opposing spectral frequencies that correspond to anaglyphic color channels.

12. A quadrascopic anaglyphic/lenticular production method, digital or non digital in whole or in part, manual or automated, for the concurrent and interactive display of four separate visual channels from one image signal consisting of two separate still or motion anaglyphic records of image or text of fixed anaglyphic color channel display orientation, comprising steps of;
a. the anaglyphic production method for anaglyphic record as claimed in claim 1 applied to two image pairs being either unrelated or interrelated resulting in two anaglyphic records;
b. the field interpolation of two separate anaglyphic records into one image signal so as to separately allocate the two anaglyphic records as odd and even field scans.

13. Apparatus for the display of quadrascopic anaglyphic/lenticular images produced in accordance with claim 12, the apparatus comprising of;
a. quadrascopic anaglyphic/lenticular images as claimed in claim 12 that may be sent or received on-line, stored and reproduced from a recording medium and received as broadcast;
b. a securable lenticular sheet consisting of an array of lenticular lenses of suitable pitch or frequency that enable an interactive vertical visual channeling of images, text or other such visual matter displayed on the field scan lines of a display device of RGB format via refraction or;
c. a display means of an odd/even field scan display device of RGB format where a lenticular array of lenses is integral with the display surface and where the orientation of the lenticular array of lenses is horizontal and consists of a frequency of lenses such that each lenticular lens covers an odd and an even field scan line so as to effect an upper and lower vertical channeling of the two anaglyphic displays containing four visual channels on the field scans via refraction;
d. an active selective color record removal means to remove the color record assigned to an anaglyphic color channel containing two visual channels to isolate an opposing anaglyphic color channel for the unaided lenticular viewing of an interactive choice between its two remaining visual channels;
e. a printing system, machine or photographic device, LED or RGB lithographic or any other such printing system of RGB format for the reproduction of two anaglyphic color channels representing four horizontally interpolated visual channels as print displayed under a lenticular array;
f. anaglyphic filter gel of single filter frequency that corresponds to an anaglyphic color channel;
g. anaglyphic filter viewing gels of opposing spectral frequencies and of fixed viewing orientation that correspond to anaglyphic color channels.

14. A quadrascopic anaglyphic/lenticular image display produced in accordance with the production method as claimed in claim 12 of still or motion quadrascopic record that exhibits;
a. monitor display of four separate visual channels as anaglyphic record of image or text that may be unrelated or interrelated in whole or in part across configurations between horizontal, vertical and diagonal image pairs and also combinations of still and motion record and combinations of two and three-dimensional record and combinations of monochromatic and color record including, color perception of concurrent horizontal and vertical parallax perceived via color corresponding anaglyphic filter gel with spectral split;
b. an unaided two-dimensional interactive choice of two lenticular visual channels from each anaglyphic channel of monitor display exhibit a, via active or passive selective color record removal means;
c. printed display of four separate visual channels of anaglyphic record of image or text that may be unrelated or interrelated in whole or in part across configurations between horizontal, vertical and diagonal image pairs and also combinations of two and three-dimensional record and combinations of monochromatic and color record including, color perception of concurrent horizontal and vertical parallax with spectral split perceived via color corresponding anaglyphic filter gel with spectral split;

15. A modulating quadrascopic anaglyphic/lenticular production method, digital or non digital in whole or in part, manual or automated, where the anaglyphic color channel displays of two separate still or motion anaglyphic records of image or text, unrelated or interrelated in whole or in part and representing four visual channels, modulate between two anaglyphic display orientations as claimed in claim 4 and are interpolated together as odd and even field scans in one image signal comprising steps of;
a. the modulating anaglyphic color channel display production method as claimed in claim 4 applied to two pairs of interrelated or unrelated visual records to enable two separate modulating anaglyphic records;
b. field interpolating the two modulating anaglyphic color channel displays of step a, as odd and even field scans.

16. A modulating quadrascopic anaglyphic/lenticular image display produced in accordance with the production method as claimed in claim 15 that exhibits;
a. quadrascopic monitor display of four separate visual channels of anaglyphic record of image or text that may be unrelated or interrelated in whole or in part across horizontal, vertical and diagonal image pair combinations where also combinations of still and motion record and combinations of two and three-dimensional record and combinations of monochromatic and color record and combinations of modulation rate all interrelate, including the color perception to both eyes simultaneously of concurrent horizontal and vertical parallax from a multiplex of anaglyphic color channels via synchronous and color corresponding electro-optic/anaglyphic filters;
b. an unaided two-dimensional monochromatic or colored interactive choice of two lenticular visual channels from each anaglyphic channel of quadrascopic monitor display exhibit a, via active modulating color record removal synchronous with a selected modulating color channel.

17. A modulating quadrascopic anaglyphic/lenticular production method where four anaglyphic display orientations modulate in a cycle as two anaglyphic channels where the two anaglyphic channels represent four visual channels, comprising steps of;
a. the modulating anaglyphic color channel display production method as claimed in claim 6 applied to two pairs of interrelated or unrelated visual records to enable two separate modulating anaglyphic records;
b. field interpolating the two modulating anaglyphic color channel displays of step a, as odd and even field scans.

18. A modulating quadrascopic anaglyphic/lenticular image display produced in accordance with the production method for modulating quadrascopic anaglyphic/lenticular image as claimed in claim 17 that exhibits;
a. quadrascopic monitor display of four separate visual channels of anaglyphic record of image or text that may be unrelated or interrelated in whole or in part across horizontal, vertical and diagonal image pair combinations where also combinations of still and motion record and combinations of two and three-dimensional record and combinations of monochromatic and fall color record and combinations of modulation rate all interrelate, including the color perception to both eyes simultaneously of concurrent horizontal and vertical parallax from a multiplex of anaglyphic primary color image planes contained within the anaglyphic channels via synchronous and color corresponding electro-optic/anaglyphic filters;
b. an unaided two-dimensional monochromatic or full colored interactive choice of two lenticular visual channels from each anaglyphic channel of quadrascopic monitor display exhibit a, via active modulating color record removal synchronous with a selected modulating color channel.

19. Apparatus for the display of modulating quadrascopic anaglyphic/lenticular image or text produced in accordance with the production method of claim 15, the apparatus comprising of;
a. modulating quadrascopic anaglyphic/lenticular image produced as claimed in claim 15;
b. a first power supply means enabling a signal detection means for the interception of the modulating program of step a, for the detection of synchronizing signals and field differentiated signals to determine the programs modulation rate and accordingly produce signals as representations of the modulation rate for transmission and also for the optional system of step c;
c. an optional color removal means to occur either in production or in post production for a conversion from a mode of modulation of two anaglyphic display orientations to a mode of modulation of four anaglyphic display orientations by effecting a selective and alternate removal of second and third colour saturation assignments from the intercepted modulating anaglyphic record of step b in a cycle of consistent frequency and initiating such effect at the incidence of synchronizing signal detection;
d. optionally and in conjunction with optional step c, a selective color luminance reducing means effecting a sustained reduction of brightness or output level of luminosity of a first color saturation assignment proportionate to it's relative over-inclusion in the resulting cycle of four modulating color channel orientations;
e. a display means of an odd/even field scan display device of RGB format where a lenticular array of lenses is contiguous or integral with the display surface and where the orientation of the lenticular array of lenses is horizontal and consists of a frequency of lenses such that each lenticular lens covers an odd and an even field scan line so as to effect an upper and lower vertical channeling of the two anaglyphic displays of four visual channels on the field scans via refraction;
f. a first power supply means enabling a means for the transmission of signals representing the index or other such synchronizing signals and signals representing the modulation rate via radio, optical or any suitable medium to a receiving means incorporated with electro-optic/anaglyphic viewing filters;
g. a second power supply means enabling a receiving means to receive a transmitted carrier signal and to detect and re-generate signals representing the index or other such synchronizing signals and signals representing the modulation rate for their delivery to a switching logic means;
h. switching logic means for the determination and selection of trigger voltages for the synchronization of electro-optic/anaglyphic filter presentations with anaglyphic colour channel displays;
i. electro-optic/anaglyphic filters consisting of a pair of electro-optic light modulating filter elements that respond to the synchronizing voltage selection of switching logic and present transitions between two filter presentations of anaglyphically opposing hues that together allow the transmission of three color saturations with a transmission of a first color saturation through one filter and a transmission of second and third color saturations through the opposing filter or;
j. electro-optic/anaglyphic filters consisting of a pair of electro-optic light modulating filter elements that respond to the synchronizing voltage selection of switching logic and present transitions between four filter presentations of anaglyphically opposed hues and where each filter element enables three color transmitting filter states that each allow the transmission of one saturated primary color where a first color filter is consistently and alternately presented for either visual channel throughout all four presentations with the second and third color filter saturations alternately opposing at equal frequency;
k. as an unaided two dimensional alternative to electro-optic parts j and k, a modulating color record removal means that responds to the synchronizing voltage selection of the switching logic of part h to effect a cycle of color record removal synchronous with a selected modulating anaglyphic color channel.

20. An autostereoscopic modulating anaglyphic/lenticular production method, digital or non digital in whole or in part, manual or automated, for a selectable choice between two autostereoscopic programs from one image signal, comprising steps of;
a. the production method as claimed in claim 15, where the four originating images consist of two stereo pairs being unrelated or interrelated where the two left views form a first anaglyphic record and the two right views form a second anaglyphic record;
b. field interpolating the first and second anaglyphic records of step a, together as odd and even field scans;
c. optionally effecting a selective and alternate removal of second and third colour saturation assignments from the odd and even field scans of step a, in a cycle of consistent frequency and initiating such effect at the incidence of synchronizing signal detection and;
d. in conjunction with optional step b, effecting a sustained reduction of brightness or output level of the luminosity of a first color saturation assignment proportionate to its relative over-inclusion in the resulting cycle of modulating color channel orientations;
e. displaying the interpolated odd and even field scans onto the odd and even fields of an RGB format display device where a lenticular array of lenses is contiguous or integral with the display surface and where the orientation of the lenticular array of lenses is vertical and consists of a frequency of lenses such that each lenticular lens covers an odd and an even field scan line so as to effect a horizontal channeling of two anaglyphic displays on the field scans via refraction;
f. effecting a modulating cycle of color record removal synchronous with the modulating color records assigned to a selected modulating anaglyphic color channel to enable an autostereoscopic perception of the remnant modulating anaglyphic records via lenticular means.

21. An autostereoscopic modulating anaglyphic/lenticular image display as claimed in claim 20 that exhibits;
a. a switch-able choice between two separate stereoscopic visual channels of anaglyphic record of image or text that may be unrelated or interrelated where also combinations of selected modulating color record removal and combinations of two and three-dimensional record and combinations of still and motion record and combinations of monochromatic and full color record and combinations of modulation rate all interrelate, including the selectable choice between two concurrent full color autostereoscopic programs from one image signal perceived in full color to both eyes simultaneously from a multiplex of anaglyphic primary color image planes contained within remnant anaglyphic color channels via selective and synchronous modulating color record removal.

22. Apparatus for the display of autostereoscopic modulating anaglyphic/lenticular image produced in accordance with the production method of claim 20 comprising of;
a. autostereoscopic modulating anaglyphic/lenticular image produced as claimed in claim 20 that may be sent or received on-line, stored and reproduced from a recording medium and received as broadcast;
b. a first power supply means enabling a signal detection means for the interception of the image supply signal of the modulating program of step a, for the detection of synchronizing signals and field differentiated signals from the program signal to determine the programs modulation rate and accordingly produce signals as representations of the modulation rate for a switching logic means of step c;
c. a switching logic means for the determination and selection of trigger voltages for the selective synchronization of an active color record removal means of step d;
d. an active color record removal means that responds to the switching logic of step c to remove a cycle of color records that correspond to and synchronize with a selected cycle of modulating anaglyphic color channels;
e. a display means of an odd/even field scan display device of RGB format where a lenticular array of lenses is contiguous or integral with the display surface and where the orientation of the field scans and that of the lenticular array of lenses is vertical and consists of a frequency of lenses such that each lenticular lens covers an odd and an even field scan line so as to effect a horizontal channeling of the two remnant anaglyphic displays on the field scans via refraction.

23. A quadrascopic lenticular/strobe production method, digital or non digital in whole or in part, manual or automated, where two still or motion displays of image or text being unrelated or interrelated in whole or in part and representing four visual channels, alternate sequentially as two representations for left views and two representations for right views, including steps of;
a. isolating any two image pairs of separate records of image or text being unrelated or interrelated as a first pair and a second pair;
b. interpolating a first image pair of step a, together at a first frequency as a first interpolated record and interpolating a second image pair of step a, together at a first frequency as a second interpolated record;
c. interpolating the first interpolated record of step b with the second interpolated record of step b at a frequency half that of the first frequency;
d. effecting the application of index or synchronizing signals or pulses to the incidence of interpolation at a consistent frequency;
d. display of the resultant interpolated signal onto the odd and even field lines of a display means.

24. Apparatus for the display of quadrascopic lenticular/strobe produced in accordance with the production method of claim 23, the apparatus comprising of;
a. quadrascopic lenticular/strobe image produced as claimed in claim 23;
b. a first power supply means enabling a signal detection means for the detection of synchronizing signals and field differentiated signals from the quadrascopic program of step a, to determine the programs strobe rate and accordingly produce signals as representations of the strobe rate for transmission;
c. a display means of an odd/even field scan display device where a lenticular array of lenses is contiguous or integral with the display surface and where the orientation of the lenticular array of lenses is horizontal and consists of a frequency of lenses such that each lenticular lens covers an odd and an even field scan line so as to effect an upper and lower vertical channeling of the two anaglyphic displays on the field scans via refraction;
d. a means for the transmission of synchronizing signals and signals representing the strobe rate via radio, optical or any suitable medium to a receiving means incorporated with electro-optic/shutters;
e. a second power supply means enabling a receiving means to receive a transmitted carrier signal and to detect and re-generate signals representing synchronizing signals and signals representing the strobe rate for their delivery to a switching logic means;
f. switching logic means for the determination and selection of trigger voltages for the synchronization of electro-optic/shutter presentations with lenticular/strobe displays;
g. electro-optic/shutter glasses consisting of a pair of electro-optic light valve elements that respond to the synchronizing voltage selection of switching logic of step f and present alternations between open and shut states so that at any instant one shutter is open for view and the other shutter is shut for view.

25. Apparatus for the production of anaglyphic images, the apparatus consisting of;
a. an anaglyphic camera for still or motion stereoscopic capture and any multiplicity stereoscopic capture of two or more pairs of image or text for digital or non-digital processing having such effect as claimed in claim 4 and that may process externally sourced input signals;
b. computer software having such effect as claimed in claim 4 for still or motion record processing;
c. integrated circuitry having such effect as claimed in claim 4 for still or motion record processing;
d. separate analogue and or digital components in series having such effect as claimed in claim 4
e. a red/green/blue color record removal filter/switch that responds to switching logic to selectively and synchronously remove a color record or a cycle of color records selected for removal that corresponds to and or synchronizes with a color record or a cycle of modulating color records that anaglyphically contain one or more visual channels of image or text to reveal an unaided and interactive choice of programs from the remnant anaglyphic color channel displays.
